(19) United States
(12) Patent Application Publication
(10) Pub. No.: US 2022/0403652 A1
(43) Pub. Date: Dec. 22, 2022

(54) SOUND ABSORBING STRUCTURE AND SOUND ABSORBING WALL

(71) Applicant: Pixie Dust Technologies, Inc., Tokyo (JP)

(72) Inventors: Yudai TAIRA, Tokyo (JP); Masaki GOMI, Tokyo (JP); Kazuki MIURA, Tokyo (JP)

(73) Assignee: Pixie Dust Technologies, Inc., Tokyo (JP)

(21) Appl. No.: 17/895,258

(22) Filed: Aug. 25, 2022

Related U.S. Application Data
(63) Continuation of application No. PCT/JP2021/008104, filed on Mar. 3, 2021.

(30) Foreign Application Priority Data
Mar. 13, 2020 (JP) 2020-043645
Mar. 1, 2021 (JP) 2021-031928

(51) Int. Cl. E04C 1/39; G10K 11/172; G10K 11/04; E04B 1/84

(52) U.S. Cl. CPC E04C 1/39; G10K 11/172; G10K 11/04; E04B 1/8404

(57) ABSTRACT

A sound absorbing structure includes a perforated surface with a plurality of through-holes, a first cavity that has a portion extending non-parallel to a normal direction of the perforated surface, the first cavity being breathable between an interior and exterior of the first cavity via the plurality of through-holes existing in a first region of the perforated surface, and a second cavity that is breathable between an interior and exterior of the second cavity via the plurality of through-holes existing in a second region adjacent to the first region of the perforated surface.

### CROSS-REFERENCE TO RELATED APPLICATIONS

This application is a Continuation Application of No. PCT/JP2021/008104, filed on Mar. 3, 2021, and the PCT application is based upon and claims the benefit of priority from Japanese Patent Application No. 2020-043645, filed on Mar. 13, 2020, and Japanese Patent Application No. 2021-031928, filed on Mar. 1, 2021, the entire contents of which are incorporated herein by reference.

### TECHNICAL FIELD

This disclosure relates to sound absorbing structures.

### BACKGROUND ART

The suppression of noise generated by railroads, highways, and construction sites is one of the important social issues. In particular, effective absorption of noise in the low frequency band is required.

Reference 1 (Wu, F., Xiao, Y., Yu, Di., Zhao, H., Wang, Y., & Wen, J. (2019). Low-frequency sound absorption of hybrid absorbers based on micro-perforated panels and coiled-up channels. Applied Physics Letters, 114(15). Available from: https://doi.org/10.1063/1.5090355) proposes a sound absorbing structure containing an S-shaped waveguide bent twice in the 180-degree direction. The thickness of the sound absorbing structure (the dimension perpendicular to the reference plane, which is the plane of the surface of the sound absorbing structure that includes the open end of the waveguide) is about ⅓ times the length of the waveguide. Therefore, such a sound absorbing structure can effectively absorb low-frequency sound while suppressing thickness.

In the sound absorbing structure of Reference 1, a perforated plate is provided at the open end of the waveguide. The acoustic impedance can be adjusted via the hole parameters of such perforated plates. The thermo-viscous resistance of the perforated plate also has the effect of lowering the Q value.

In the sound absorbing structure of Reference 1, the ratio of the area of the open end of the waveguide to the reference plane is only about ⅓. The smaller the ratio of the area of the open end of the waveguide to the reference plane, the higher the Q value. In other words, this sound absorbing structure has a narrow frequency bandwidth in which high sound absorption coefficient can be achieved.

### BRIEF DESCRIPTION OF DRAWINGS

FIG. 1 is a perspective view of the sound absorbing structure of the first embodiment.

FIG. 2 is a DW cross-sectional view of the sound absorbing structure of the first embodiment.

FIG. 3 is a Figure showing a noise barrier with sound absorbing structure of the first embodiment.

FIG. 4 is an outline illustration of the first embodiment.

FIG. 5 is a perspective view of the sound absorbing structure of the second embodiment.

FIG. 6 is a DW cross-sectional view of the sound absorbing structure of the second embodiment.

FIG. 7 is a perspective view of the sound absorbing structure of Modification 1.

FIG. 8 is a DW cross-sectional view of the sound absorbing structure of Modification 1.

FIG. 9 is a perspective view of the sound absorbing structure of Modification 2.

FIG. 10 is a DW cross-sectional view of the sound absorbing structure of Modification 2.

FIG. 11 is a perspective view of the sound absorbing structure of Modification 3.

FIG. 12 is a DW cross-sectional view of the sound absorbing structure of Modification 3.

FIG. 13 is a DW cross-sectional view of sound absorbing structures of one of other modifications.

FIG. 14 is a DW cross-sectional view of sound absorbing structures of one of other modifications.

FIG. 15 is a HW cross-sectional view of sound absorbing structures of one of other modifications.

FIG. 16 is a DW cross-sectional view of sound absorbing structures of one of other modifications.

FIG. 17 is a DW cross-sectional view of sound absorbing structures of one of other modifications.

FIG. 18 is a perspective view of the sound absorbing structure of Modification 4.

FIG. 19 is a perspective view of the sound absorbing structure of Modification 5.

FIG. 20A is a DW cross-sectional view of the sound absorbing structure of Modification 6.

FIG. 20B is a DW cross-sectional view of the sound absorbing structure of a comparative example.

FIG. 21 is a perspective view of the support unit that supports the sound absorbing structure.

FIG. 22 is an illustration of the support of the sound absorbing structure by the support unit.

FIG. 23A is an illustration of a modification of a sound absorbing wall.

FIG. 23B illustrates how multiple sound absorbing structures are assembled in a modification of a sound absorbing wall.

### DETAILED DESCRIPTION

Hereinafter, an embodiment of the present disclosure is described in detail based on the drawings. Note that, in the drawings for describing the embodiments, the same components are denoted by the same reference sign in principle, and the repetitive description thereof is omitted.

According to an aspect of the present disclosure, a sound absorbing structure comprises a perforated surface with a plurality of through-holes, a first cavity that has a portion extending non-parallel to a normal direction of the perforated surface, the first cavity being breathable between an interior and exterior of the first cavity via the plurality of through-holes existing in a first region of the perforated surface, and a second cavity that is breathable between an interior and exterior of the second cavity via the plurality of through-holes existing in a second region adjacent to the first region of the perforated surface.

In the following description, “D-direction” is the direction of incidence of sound waves to the sound absorbing structure, which can also be referred to as the thickness direction. The “H direction” is the height direction of the sound absorbing structure. The “W direction” is orthogonal to the “D direction” and the “H direction” and can also be called the width direction.

### (1) First Embodiment

### (1-1) Configuration of Sound Absorbing Structure

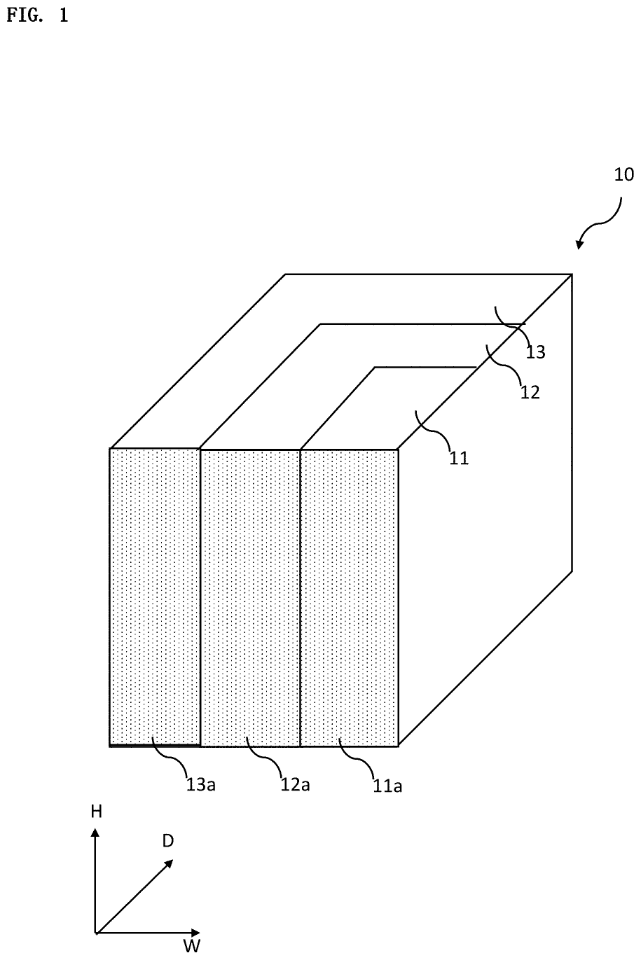

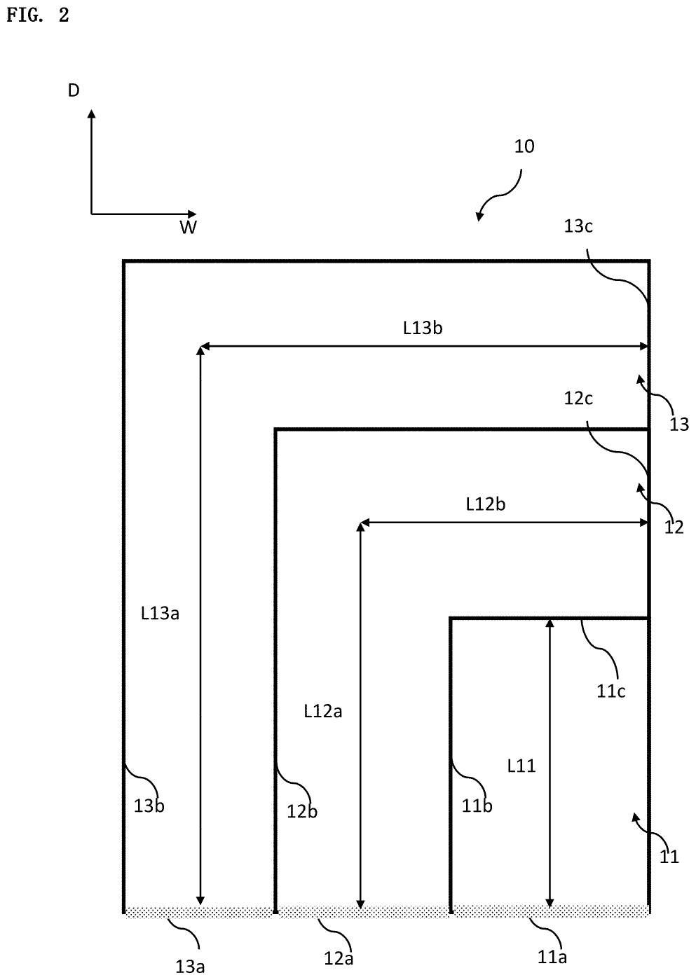

The configuration of the sound absorbing structure is described below. FIG. 1 is a perspective view of the sound absorbing structure of the first embodiment. FIG. 2 is a DW cross-sectional view of the sound absorbing structure of the first embodiment. The sound absorbing structure 10 is a member with a specific structure that has a sound absorbing effect, reducing the sound pressure of reflected sound and transmitted sound by absorbing the energy of sound waves traveling toward the sound absorbing structure 10.

As shown in FIG. 1, the sound absorbing structure 10 has a first waveguide 11, a second waveguide 12, a third waveguide 13, and a perforated plate. The first to third waveguides 11-13 are stacked in the width direction (W direction) and thickness direction (D direction). Each waveguide in the sound absorbing structure 10 is a cavity that functions as a resonator, and sound waves incident on the perforated plate can enter into each waveguide. The first waveguide 11 and the second waveguide 12 are adjacent to each other via a sidewall, and the second waveguide 12 and the third waveguide 13 are adjacent to each other via a sidewall. The first waveguide 11, second waveguide 12, and third waveguide 13 overlap each other at least partially when viewed from the D direction. The first, second, and third waveguides function as resonators with different resonance characteristics from each other.

As shown in FIG. 2, the first waveguide 11 has a first open end 11a, a first sidewall 11b, and a first closed end 11c. The length of the first waveguide 11 is represented by L11.

The first open end 11a is provided with a first perforation plate having a plurality of holes (an example of “first holes”) through which sound waves can be incident. The first perforated plate corresponds to an acoustic impedance matching component.

The first sidewall 11b connects the first open end 11a and the first closed end 11c. In the example in FIG. 2, the DW cross section of the contour of the first sidewall 11b is rectangular, in other words, I shape. That is, the first waveguide 11 extends parallel to the normal direction of the perforated plate.

The first closed end 11c is provided with a reflective wall capable of reflecting sound waves.

As shown in FIG. 2, the second waveguide 12 has a second open end 12a, a second sidewall 12b, and a second closed end 12c. The second waveguide 12 is stacked with respect to the first waveguide 11 in the W and D directions. Specifically, the second waveguide 12 is arranged such that a second open end 12a is in contact with the first open end 11a and the second sidewall 12b is in contact with the first sidewall 11b and the first closed end 11c.

The length of the second waveguide 12 is L12a+L12b. The length of the second waveguide 12 is longer than the length of the first waveguide 11. In other words, the second waveguide 12 absorbs sound waves of lower frequency than the first waveguide 11.

The second open end 12a is provided with a second perforation plate having a plurality of holes (an example of “second holes”) through which sound waves can enter. The second perforated plate corresponds to an acoustic impedance matching component.

The second sidewall 12b connects the second open end 12a and the second closed end 12c. The shape of the second sidewall 12b is determined such that the length of the second waveguide 12 is longer than the D-axis component of the linear distance between the second open end 12a and the second closed end 12c. In other words, the second sidewall 12b includes a portion that extends non-parallel to the direction normal to the second open end 12a (i.e., the normal direction of the perforated plate, that is, the D axis direction).

In the example in FIG. 2, the DW cross section of the contour of the second sidewall 12b is a rectangle bent once at 90 degrees, in other words, it is L-shaped. In short, the second sidewall 12b has a first portion extending along the first straight line (normal to the second open end 12 a) (i.e., parallel to the D-axis direction) and a second portion extending along a second straight line (normal to the second closed end 12c) that intersects the first straight line, and the angle formed by the first straight line and the second straight line (an example of “first angle”) is 90 degrees. That is, the second portion extends from the first portion perpendicular to the D-axis direction.

The second closed end 12c is provided with a reflective wall that can reflect sound waves.

As shown in FIG. 2, the third waveguide 13 has a third open end 13a, a third sidewall 13b, and a third closed end 13c. The third waveguide 13 is stacked with respect to the second waveguide 12 in the W and D directions. Specifically, the third waveguide 13 is arranged such that a third open end 13a is in contact with the second open end 12a and the third sidewall 13b is in contact with the second sidewall 12b.

The length of the third waveguide 13 is L13a+L13b. The length of the third waveguide 13 is longer than the length of the second waveguide 12. In other words, the third waveguide 13 absorbs sound waves of lower frequency than the second waveguide 12.

The third open end 13a is provided with a third perforation plate having a plurality of holes (an example of “third holes”) through which sound waves can enter. The third perforated plate corresponds to an acoustic impedance matching component.

The third sidewall 13b connects the third open end 13a and the third closed end 13c. The shape of the third sidewall 13b is determined so that the length of the third waveguide 13 is longer than the D-axis component of the linear distance between the third open end 13a and the third closed end 13c. In other words, the third sidewall 13b includes a portion that extends non-parallel to the normal of the third open end 13a (i.e. D axis).

In the example in FIG. 2, the DW cross section of the contour of the third sidewall 13b is a rectangle bent once at 90 degrees, in other words, it is L-shaped. In short, the third sidewall 13b has a first portion extending along a first straight line (normal to the third open end 13a) and a second portion extending along a second straight line (normal to the third closed end 13c) that intersects the first straight line, and the angle formed by the first straight line and the second straight line is 90 degrees.

The third closed end 13c is provided with a reflective wall capable of reflecting sound waves.

Thus, the sound absorbing structure 10 includes a first waveguide 11, a second waveguide 12, and a third waveguide 13. Therefore, the sound absorbing structure 10 has a sound absorption coefficient characteristic (e.g., acoustic impedance and Q-value) that peaks at three resonance frequencies and harmonics of the three resonance frequencies. (e.g., at least one of the acoustic impedance and Q-value). The sound absorbing structure 10 can be used to achieve a sound absorbing effect over a wider frequency range than when a single waveguide is used. The sound absorption characteristics of the sound absorbing structure 10 in this embodiment are expressed, for example, by sound absorption coefficient per frequency or acoustic impedance.

The lowest peak frequency depends on the length of the third waveguide 13. As mentioned above, since the third sidewall 13b has an L-shaped contour with a DW cross section, the third waveguide 13 has a small thickness relative to its length. Therefore, the thickness of the sound absorbing structure 10 (i.e., the dimension in direction D) is smaller than L13 a+L13b, which corresponds to the length of the third waveguide.

In the sound absorbing structure 10, the reference plane, which is the plane of the surface of the sound absorbing structure that includes the open ends of the waveguide, comprises the first open end 11a, the second open end 12a, and a third open end 13a. In other words, if we ignore the HW cross sections of the first sidewall 11b, the second sidewall 12b, and the third sidewall 13b, the ratio of the area of the open end of the waveguide to the reference plane is 100%. Therefore, the Q-value of the sound absorbing structure 10 is lower (the sound absorption coefficient characteristic is not steep), and the sound absorption coefficient is less likely to decrease at frequencies away from the peak frequency. The hole parameters of the perforated plate at the open end of each waveguide are optimized according to the required sound absorption coefficient characteristics of the waveguide. In other words, according to the sound absorbing structure 10, a high sound absorption coefficient can be achieved over a wide bandwidth.

### (1-1-1) Configuration of Perforated Plate

The perforated plate is a flat member with a plurality of through-holes. Perforated plates can include, for example, at least one of porous resin, porous metal, porous polymer, and nonwoven fabric.

The sound absorption coefficient characteristics of each waveguide are determined by the shape of the waveguide and the parameters of the perforated plate provided by the waveguide (hereinafter referred to as “hole parameters”). The hole parameters include, for example, at least one of the following:

area of the HW plane (i.e., the plane of incidence of sound waves) of the perforated plate;

thickness of perforated plate (dimension in direction D);

hole diameter;

percentage of the area of the hole in the HW plane of the perforated plate (hereinafter referred to as “hole occupancy”);

hole shape;

number of holes; and

hole spacing.

As specific parameters, for example, the length of the sound absorbing structure 10 in the H, D and W directions is 3 cm to 10 cm, and the thickness of the perforated plate is 0.5 mm to 3 mm, the diameter of the holes in the perforated plate is set to 0.3 mm to 2 mm And by setting other parameters such as the number of holes in the perforated plate appropriately, it is possible to efficiently absorb (reduce sound pressure) sounds between 400 Hz and 1500 Hz, the main component of sound in human conversation. In this case, the average sound absorption coefficient of sound between 400 Hz and 1,500 Hz by the sound absorbing structure 10 is higher than the average sound absorption coefficient of the other frequency bands (i.e., frequency bands lower than 400 Hz and higher than 1500 Hz) by the sound absorbing structure 10. The sound absorption characteristics of the sound absorbing structure 10 can be varied by adjusting at least any of the waveguide shape and hole parameters. For example, the sound absorbing structure 10 can be designed to efficiently absorb sounds between 1000 Hz and 4000 Hz, or the sound absorbing structure 10 can be designed to efficiently absorb sounds between 200 Hz and 2500 Hz.

By having the multiple waveguides of the sound absorbing structure 10 have different sound absorption characteristics, the sound absorbing structure 10 as a whole can absorb sound waves in a wide bandwidth. The frequency bands of the sound waves absorbed by each waveguide may be set so that they do not overlap each other, or may overlap in part. Multiple waveguides may have the same sound absorption characteristics if, for example, the Q-value of the sound absorption spectrum is lowered to strengthen the sound absorption effect in the frequency band near a particular frequency.

In the first example of the perforated plate configuration, the parameters of each perforated plate (as an example, the hole occupancy) are designed individually for each waveguide. In other words, the hole parameters of the first perforated plate are optimized according to the required sound absorption coefficient characteristics of the first waveguide 11. The hole parameters of the second perforated plate are optimized according to the required sound absorption coefficient characteristics of the second waveguide 12. The hole parameters of the third perforated plate are optimized according to the required sound absorption coefficient characteristics of the third waveguide 13. Consequently, the hole parameters of the first perforated plate, the hole parameters of the second perforated plate, and the hole parameters of the third perforated plate can differ from each other.

According to the first example of the perforated plate configuration, the hole parameters of the perforated plate at the open end of each waveguide are optimized according to the required sound absorption coefficient characteristics of the waveguide, so the sound absorption structure 10 can achieve high sound absorption over a wide bandwidth.

In the second example of the perforated plate configuration, the parameters of each perforated plate are designed to be common between waveguides. That is, the hole parameters of the first perforated plate are identical to the hole parameters of the second and third perforated plates.

According to the second example of the perforated plate configuration, the specifications of each perforated plate can be standardized, which is expected to improve manufacturing efficiency.

The plurality of perforated plates at the open ends of the plurality of waveguides that the sound absorbing structure 10 contains may be constructed as a single unit. The perforated plate and waveguide may be constructed as a single unit. In other words, the sound absorbing structure 10 should have a perforated surface with a plurality of through-holes and a plurality of waveguides, each corresponding to a different area of the perforated surface. The interior of each waveguide and the exterior can be vented through a plurality of through-holes located in corresponding areas of the perforated surface.

### (1-2) Outline of Embodiment

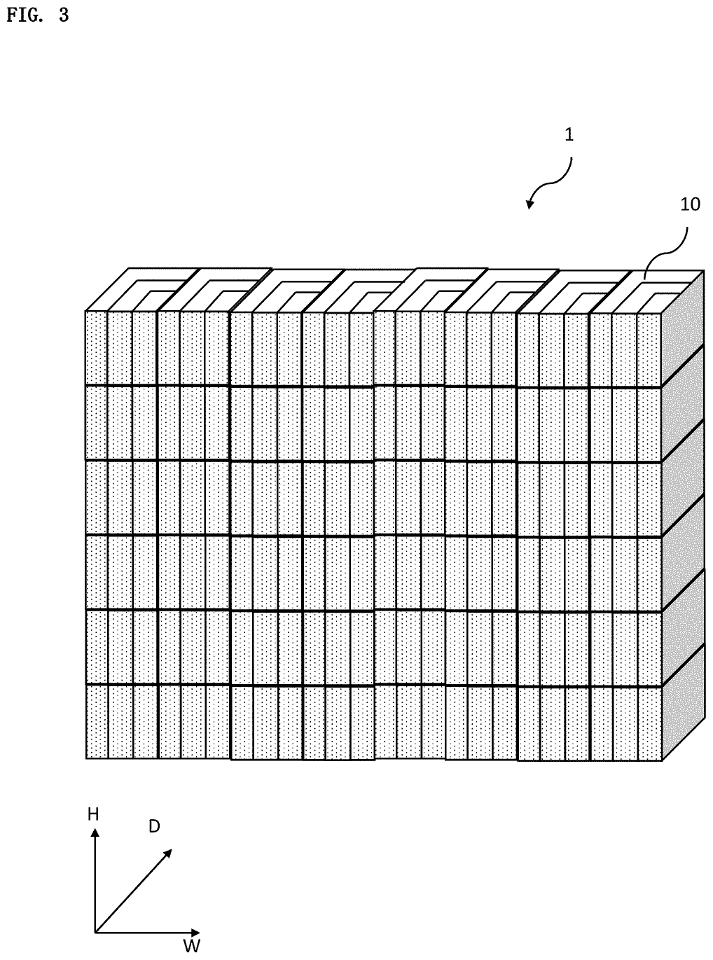

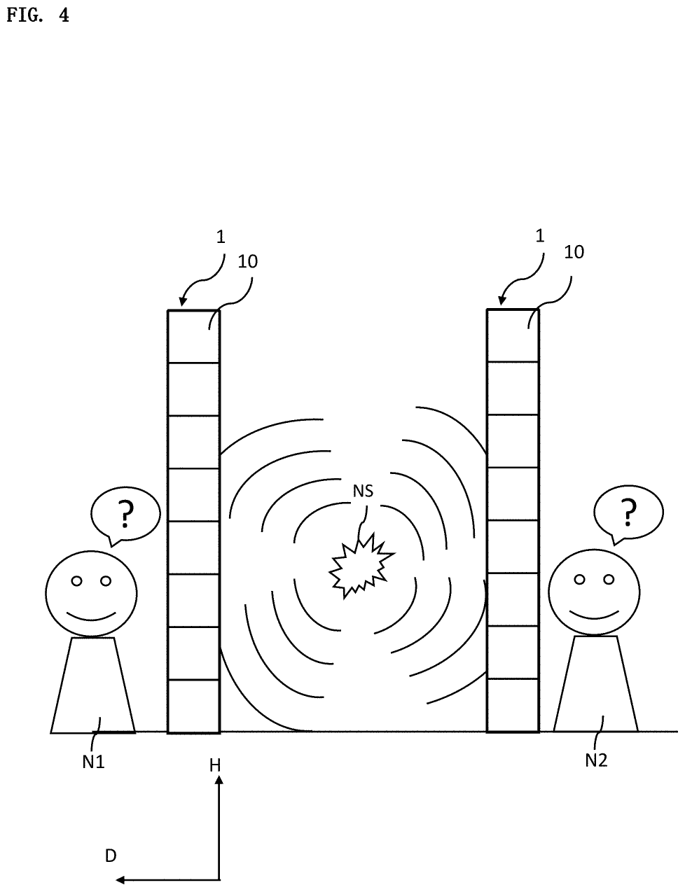

The following is an outline of the first embodiment. FIG. 3 shows a noise barrier (also called a sound absorbing wall) using the sound absorbing structure of the first embodiment. The figure shows a FIG. 4 is an outline illustration of the first embodiment.

As shown in FIG. 3, the sound absorbing structure 10 of the first embodiment can be applied to a noise barrier 1. The noise barrier 1 has a plurality of sound absorbing structures 10 stacked along the H and W directions. In the noise barrier 1, the plurality of perforated surfaces of the plurality of sound absorbing structures 10 are arranged next to each other. As shown in FIG. 4, by arranging the noise barrier 1 so that the open end of the sound absorbing structure 10 faces toward the noise source NS, the noise barrier 1 can absorb the noise generated by the noise source NS. Therefore, people N1 and N2 in the neighborhood are not aware of the presence of noise.

The sound absorbing structure 10 of the first embodiment achieves both effective absorption of low-frequency sound and thickness suppression by making the third waveguide 13, which is the longest, a bent shape. The sound absorbing structure 10 is equipped with multiple types of waveguides of different lengths and perforated plates at the open end of each waveguide to achieve high sound absorption over a wide bandwidth. Therefore, according to the sound absorbing structure 10, the noise barrier 1 can effectively absorb sound waves in various frequency bands, including low-frequency sound, and can be configured to be thin.

### (2) Second Embodiment

### (2-1) Configuration of Sound Absorbing Structure

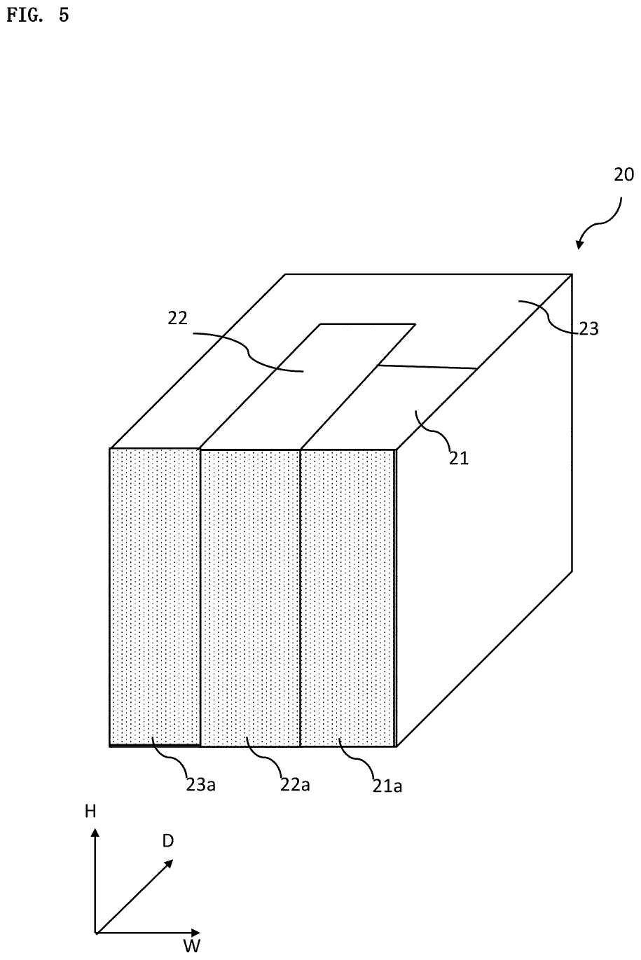

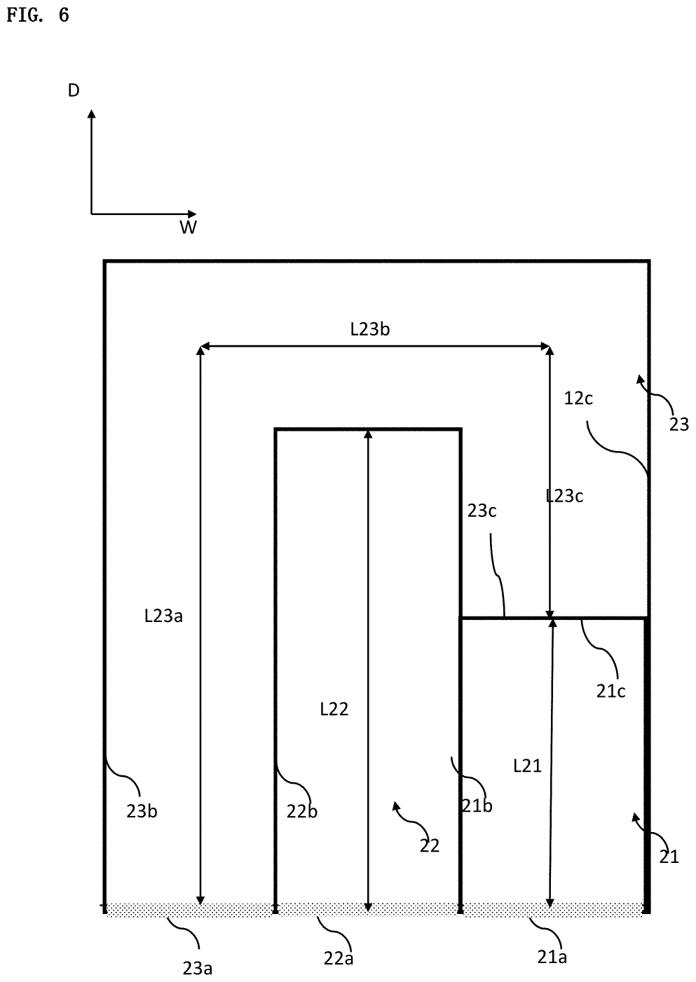

The configuration of the sound absorbing structure is described below. FIG. 5 is a perspective view of the sound absorbing structure of the second embodiment. FIG. 6 is a DW cross-sectional view of the sound absorbing structure of the second embodiment.

As shown in FIG. 5, the sound absorbing structure 20 has a first waveguide 21, a second waveguide 22, and a third waveguide 23.

As shown in FIG. 6, the first waveguide 21 has a first open end 21a, a first sidewall 21b, and a first closed end 21c. The length of the first waveguide 21 is represented by L21.

The first open end 21a is provided with a first perforated plate having a plurality of holes through which sound waves can enter. The first perforated plate corresponds to an acoustic impedance matching component.

The first sidewall 21b connects the first open end 21a and the first closed end 21c. In the example in FIG. 6, the DW cross section of the contour of the first sidewall 21b is rectangular, in other words, I shape.

The first closed end 21c is provided with a reflective wall capable of reflecting sound waves.

As shown in FIG. 6, the second waveguide 22 has a second open end 22a, a second sidewall 22b, and a second closed end 22c. The second waveguide 22 is stacked along the W direction with respect to the first waveguide 21. Specifically, the second waveguide 22 is arranged such that a second open end 22a is in contact with the first open end 21a and the second sidewall 22b is in contact with the first sidewall 21b.

The length of the second waveguide 22 is represented by L22. The length of the second waveguide 22 is longer than the length of the first waveguide 21. In other words, the second waveguide 22 absorbs sound waves of lower frequency than the first waveguide 21.

A second perforated plate with a plurality of holes through which sound waves can enter is provided at the second open end 22a. The second perforated plate corresponds to an acoustic impedance matching component.

The second sidewall 22b connects the second open end 22a and the second closed end 22c. In the example in FIG. 6, the DW cross section of the contour of the first sidewall 21b is rectangular, in other words, I shape.

The second closed end 22c is provided with a reflective wall that can reflect sound waves.

As shown in FIG. 6, the third waveguide 23 has a third open end 23a, a third sidewall 23b, and a third closed end 23c. The third waveguide 23 is stacked with respect to the second waveguide 22 in the W and D direction and stacked with respect to the first waveguide 21 in the D direction. Specifically, the third waveguide 23 is arranged such that a third open end 23a is in contact with the second open end 22a, the third sidewall 23b is in contact with the second sidewall 22b and the second closed end 22c and the third closed end 23c is in contact with the first closed end 21c.

The length of the third waveguide 23 is expressed as L23a+L23b+L23c, and where L23a>L23c. By setting L23a>L23c, the third waveguide 23 can be arranged so that the third closed end 23c is in contact with the first closed end 21c. This prevents a decrease in the ratio of the area of the open end of the waveguide to the reference plane of the sound absorbing structure 10c (i.e., an increase in the Q value). The length of the third waveguide 23 is longer than the length of the second waveguide 22. In other words, the third waveguide 23 absorbs sound waves of lower frequency than the second waveguide 22.

A third perforated plate with a plurality of holes through which sound waves can enter is provided at the third open end 23a. The third perforated plate corresponds to an acoustic impedance matching component.

The third sidewall 23b connects the third open end 23a and the third closed end 23c. The shape of the third sidewall 23b is determined such that the length of the third waveguide 23 longer than the D-axis component of the linear distance between the third open end 23a and the third closed end 23c. In other words, the third sidewall 23b includes a portion that extends non-parallel to the normal of the third open end 23a (i.e. D axis.)

In the example in FIG. 6, the DW cross section of the contour of the third sidewall 23b is a rectangle bent twice at 90 degrees each, in other words, it is a U-shape. In short, the third sidewall 23b has a first portion extending along a first straight line (normal to the third open end 23a), a second portion extending along a second straight line that intersects the first straight line, and a third portion extending along a third straight line (normal to the third closed end 23c). The angle formed by the first straight line and the second straight line (an example of the “first angle”) and the angle formed by the second straight line and the third straight line (an example of the “second angle”) is 90 degrees. That is, the third portion extends from the second portion parallel to the D-axis direction.

The third closed end 23c is provided with a reflective wall that can reflect sound waves.

The third closed end 23c may share a reflective wall with the first closed end 21c. That is, the surface of the reflective wall serves as the first closed end 21c and the back surface of the reflective wall serves as the third closed end 23c. In this case, such reflective wall divide the interior space of the waveguide, which has open ends at both ends, into a first space from one open end (first open end 21a) to the reflective wall and a second space from the other open end (third open end 23a) to the reflective wall. By such dividing, the waveguide can be considered to be as functionally divided into a first waveguide 21 and a third waveguide 23.

Thus, the sound absorbing structure 20 includes a first waveguide 21, a second waveguide 22, and a third waveguide 23. Therefore, the sound absorbing structure 20 exhibits sound absorption coefficient characteristics with peaks at the three resonant frequencies and harmonics of the three resonant frequencies.

The lowest peak frequency depends on the length of the third waveguide 23. As mentioned above, the third sidewall 23b has a U-shaped contour in DW cross section, so the third waveguide 23 has a small thickness relative to its length. Therefore, the thickness of the sound absorbing structure 20 (i.e., the dimension in direction D) is the length of the third waveguide, L23 a+L23b+L23c, which is smaller than that of the third waveguide.

In the sound absorbing structure 20, the reference plane, which is the plane of the surface of the sound absorbing structure that includes the open ends of the waveguide, comprises the first open end 21a, the second open end 22a, and a third open end 23a. In other words, if we ignore the HW cross sections of the first sidewall 21b, the second sidewall 22b, and the third sidewall 23b, the ratio of the area of the open end of the waveguide to the reference plane is 100%. Therefore, the Q-value of the sound absorbing structure 20 is lower (the sound absorption coefficient characteristic is not steep), and the sound absorption coefficient is less likely to decrease at frequencies away from the peak frequency.

### (2-1-1) Configuration of Perforated Plate

The perforated plate is a flat member with a plurality of holes. Perforated plates can include, for example, at least one of porous resin, porous metal, porous polymer, and nonwoven fabric. The sound absorption coefficient characteristics of each waveguide are determined by the hole parameters of the perforated plate equipped with the waveguide.

In the first example of the perforated plate configuration, the parameters of each perforated plate (as an example, the hole occupancy) are designed individually for each waveguide. In other words, the hole parameters of the first perforated plate are optimized according to the required sound absorption coefficient characteristics of the first waveguide 21. The hole parameters of the second perforated plate are optimized according to the required sound absorption coefficient characteristics of the second waveguide 22. The hole parameters of the third perforated plate are optimized according to the required sound absorption coefficient characteristics of the third waveguide 23. Consequently, the hole parameters of the first perforated plate, the hole parameters of the second perforated plate, and the hole parameters of the third perforated plate can differ from each other.

According to the first example of the perforated plate configuration, the hole parameters of the perforated plate at the open end of each waveguide are optimized according to the sound absorption coefficient characteristics required for that waveguide, so the sound absorbing structure 20 can achieve high sound absorption over a wide bandwidth.

In the second example of the perforated plate configuration, the parameters of each perforated plate are designed to be common between waveguides. That is, the hole parameters of the first perforated plate are identical to the hole parameters of the second and third perforated plates.

According to the second example of the perforated plate configuration, the specifications of each perforated plate can be standardized, which is expected to improve manufacturing efficiency.

### (2-2) Outline of Embodiment?

Part or all of the sound absorbing structures 10 included in the noise barrier 1 described in the first embodiment can be replaced by the sound absorbing structure 20 of the second embodiment. In other words, the sound absorbing structure 20 can be applied to the noise barrier 1.

The sound absorbing structure 20 according to the second embodiment achieves both effective absorption of low-frequency sound and thickness suppression by making the waveguide 23, which is the longest, a bent shape. The sound absorbing structure 20 is equipped with multiple types of waveguides of different lengths and perforated plates at the open ends of each waveguide to achieve high sound absorption over a wide bandwidth. Therefore, according to the sound absorbing structure 20, the noise barrier 1 can effectively absorb sound waves in various frequency bands, including low-frequency sound, and can be configured to be thin.

### (3) Modification

Modifications of the present embodiment are described.

### (3-1) Modification 1

Modification 1 is described. Modification 1 is an example of a variable (adjustable) length of the waveguide in the direction of extension using a slidable reflector.

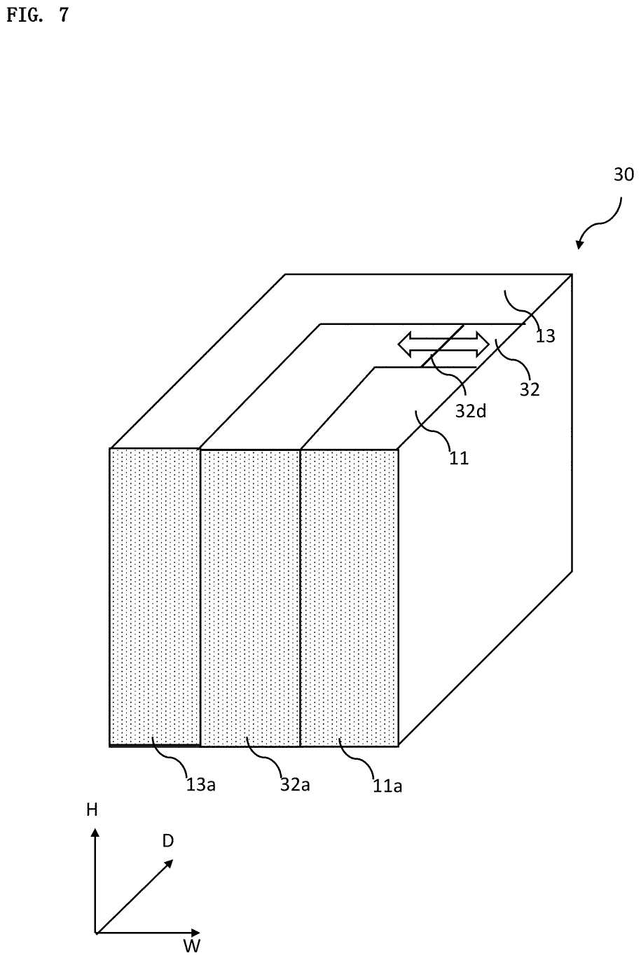

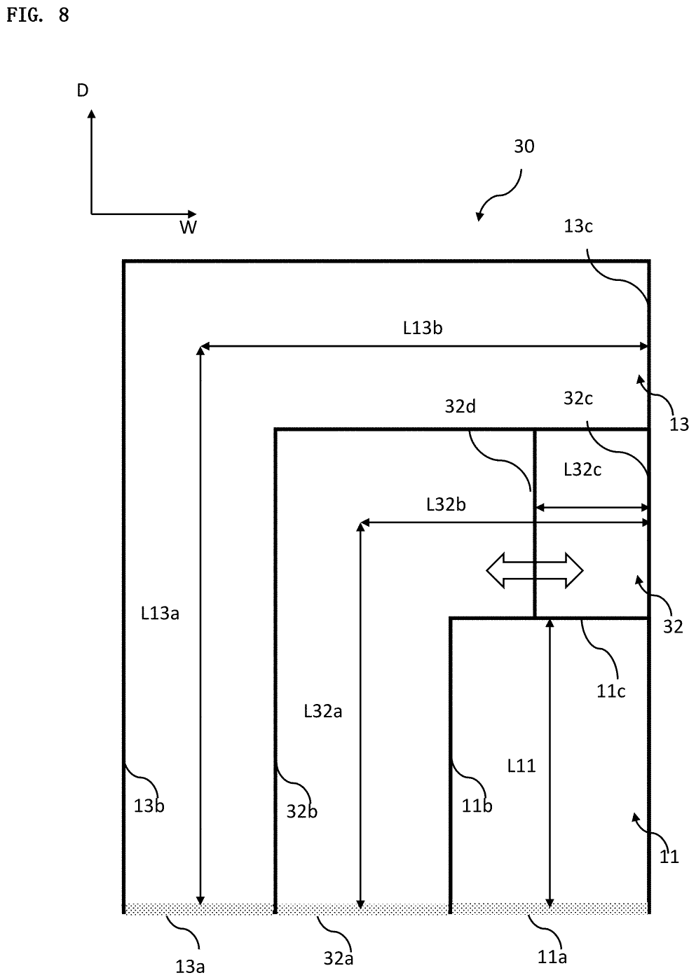

The configuration of the sound absorbing structure is described below. FIG. 7 shows a perspective view of the sound absorbing structure of Modification 1. FIG. 8 is a DW cross-sectional view of the sound absorbing structure of Modification 1.

As shown in FIG. 7, the sound absorbing structure 30 has a first waveguide 11, a second waveguide 32, and a third waveguide 13. The first waveguide 11 and third waveguide 13 are the same as in the first embodiment?.

As shown in FIG. 8, the second waveguide 32 has a second open end 32a, a second sidewall 32b, a second closed end 32c, and a reflector 32d. The second waveguide 32 is arranged such that a second open end 32a is in contact with the first open end 11a and the second sidewall 32b is in contact with the first sidewall 11b and the first closed end 11c.

The maximum length of the second waveguide 32 can be expressed as L32a+L32b. The maximum length of the second waveguide 32 is longer than the length of the first waveguide 11. In other words, the second waveguide 32 can absorb sound waves of lower frequency than the first waveguide 11.

The second open end 32a is the same as the second open end 12a according to the first embodiment.

The second sidewall 32b is the same as the second sidewall 12b according to the first embodiment.

The second closed end 32c is the same as the second closed end 12c according to the first embodiment.

The reflector 32d is configured to be able to slide within the second waveguide 32 between the second open end 32a and the second closed end 32c. As shown in FIG. 8, the reflector 32d divides the interior space of the second sidewall 32b into two spaces, one from the second open end 32a to the reflector 32d and the other from the reflector 32d to the second closed end 32c. In other words, if the distance from the reflector 32d to the second closed end 32c is L32c, the reflector 32d effectively limits the length of the second waveguide to L32a+L32b−L32c. The size of L32c can be adjusted via the position of the reflector 32d.

In short, the resonance frequency of the second waveguide 32 can be adjusted by changing the position of the reflector 32d. Therefore, according to the sound absorbing structure 30 of Modification 1, it is possible to customize the resonance frequency according to the frequency characteristics of the noise to be absorbed, while standardizing the basic structure such as the shape and dimensions of each waveguide tube.

In the above description, the second waveguide 12 in the sound absorbing structure 10 of the first embodiment was replaced by a second waveguide 32. However, the resonance frequency of any waveguide included in the sound absorbing structure described in the first and second embodiments can be made variable by attaching a slidable reflector to the waveguide.

### (3-2) Modification 2

Modification 2 is described. Modification 2 is an example in which a removable reflector is used to make the length of the waveguide variable in the direction of extension.

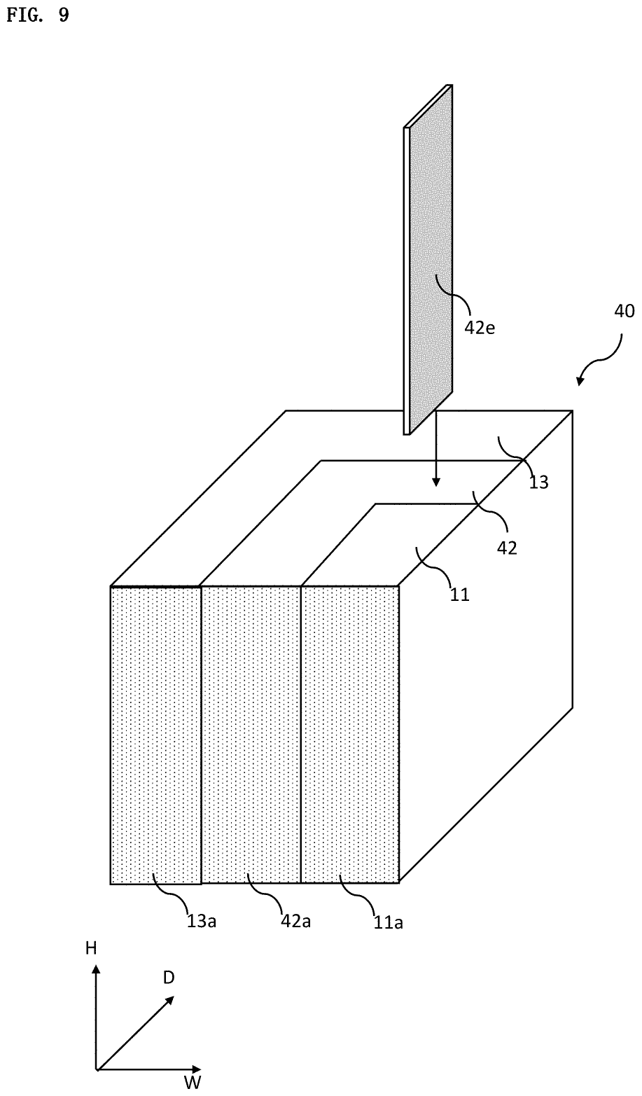

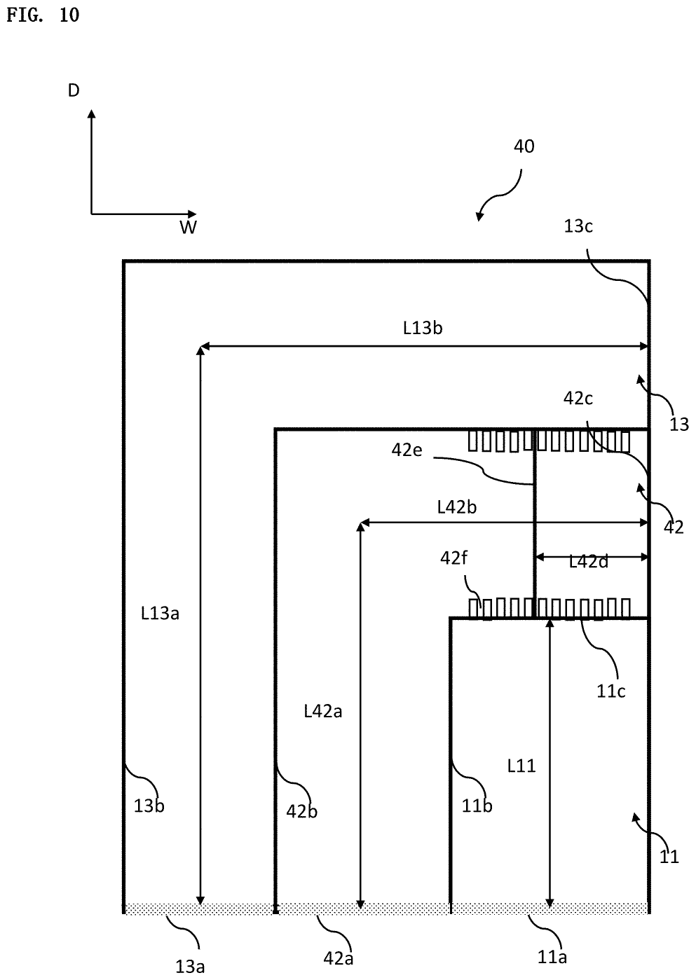

The configuration of the sound absorbing structure is described below. FIG. 9 shows a perspective view of the sound absorbing structure of Modification 2. FIG. 10 shows a DW cross section of the sound absorbing structure of Modification 2.

As shown in FIG. 9, the sound absorbing structure 40 has a first waveguide 11, a second waveguide 42 and a third waveguide 13. The first waveguide 11 and third waveguide 13 are the same as in the first embodiment.

As shown in FIG. 10, the second waveguide 42 has a second open end 42 a, a second sidewall 42b, and a second closed end 42c. The second waveguide 42 is arranged such that a second open end 42a is in contact with the first open end 11a and the second sidewall 42b is in contact with the first sidewall 11b and the first closed end 11c.

The maximum length of the second waveguide 42 is L42a+L42b. The maximum length of the second waveguide 42 is longer than the length of the first waveguide 11. In other words, the second waveguide 42 can absorb sound waves of lower frequency than the first waveguide 11.

The second open end 42a is the same as the second open end 12 according to the first embodiment.

The second closed end 42c is the same as the second closed end 12c according to the first embodiment.

The second sidewall 42b differs from the second sidewall 12b of the first embodiment in that it has a groove 42f at that location between the second open end 42a and the second closed end 42c. A reflector 42e capable of reflecting sound waves can be attached the groove 42f. In other respects, the second sidewall 42b is identical to the second sidewall 12b.

By inserting the reflector 42e into one of the grooves 42f, the reflector 42e can be attached to the second waveguide 42. By pulling the reflector 42e out of the groove 42f, the reflector 42e can be removed from the second waveguide 42. As shown in FIG. 10, the reflector 42e divides the interior space of the second sidewall 42b into two spaces, one from the second open end 42a to the reflector 42e and the other from the reflector 42e to the second closed end 42c. In other words, if the distance from the reflector 42e to the second closed end 42c is L42d, the reflector 42e effectively limits the length of the second waveguide to L42a+L42b-L42d. The size of L42d can be adjusted via the position of the reflector 42e.

In short, the second waveguide 42 can adjust the resonance frequency by changing the position of the reflector 42e. Therefore, according to the sound absorbing structure 40 of Modification 2, it is possible to customize the resonance frequency according to the frequency characteristics of the noise to be absorbed while standardizing the basic structure such as the shape and dimensions of each waveguide tube.

In the above description, the second waveguide 12 in the sound absorbing structure 10 of the first embodiment was replaced by a second waveguide 42. However, by providing a groove in the sidewall of any waveguide included in the sound absorbing structure 10 or any waveguide included in the sound absorbing structure 20 of the second embodiment, and by attaching a removable reflector to the waveguide, the length of the waveguide can be varied. This allows the resonant frequency of the waveguide to be adjusted according to the position of the reflector installation.

### (3-3) Modification 3

Modification 3 is described. Modification 3 is an example of a three-dimensional member with a plurality of waveguides is configured so that the perforated plate can be attached to and detached from it.

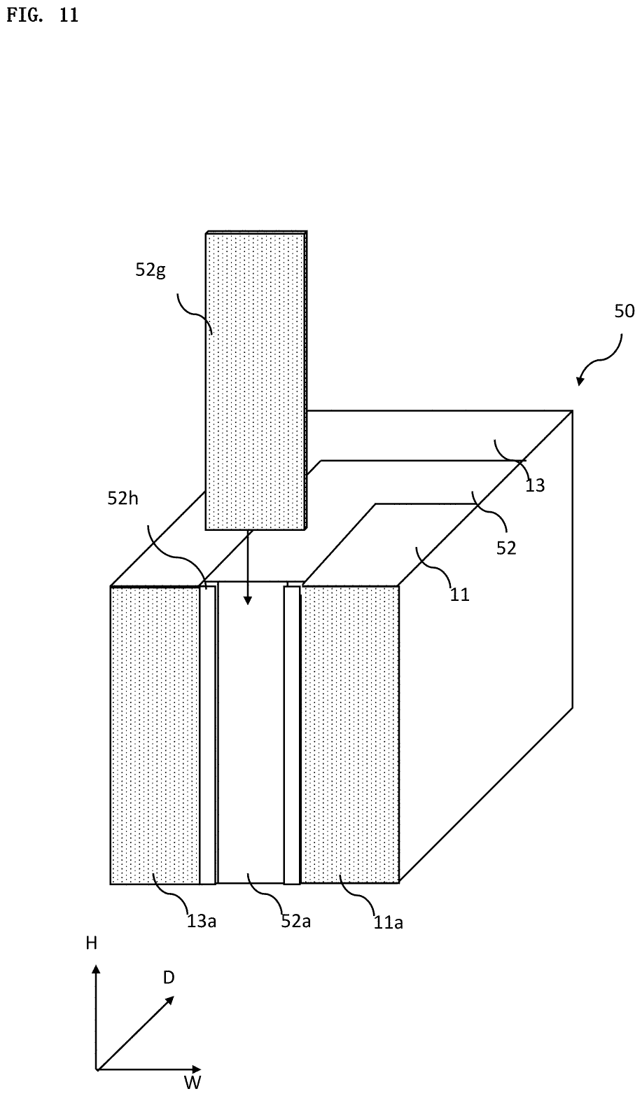

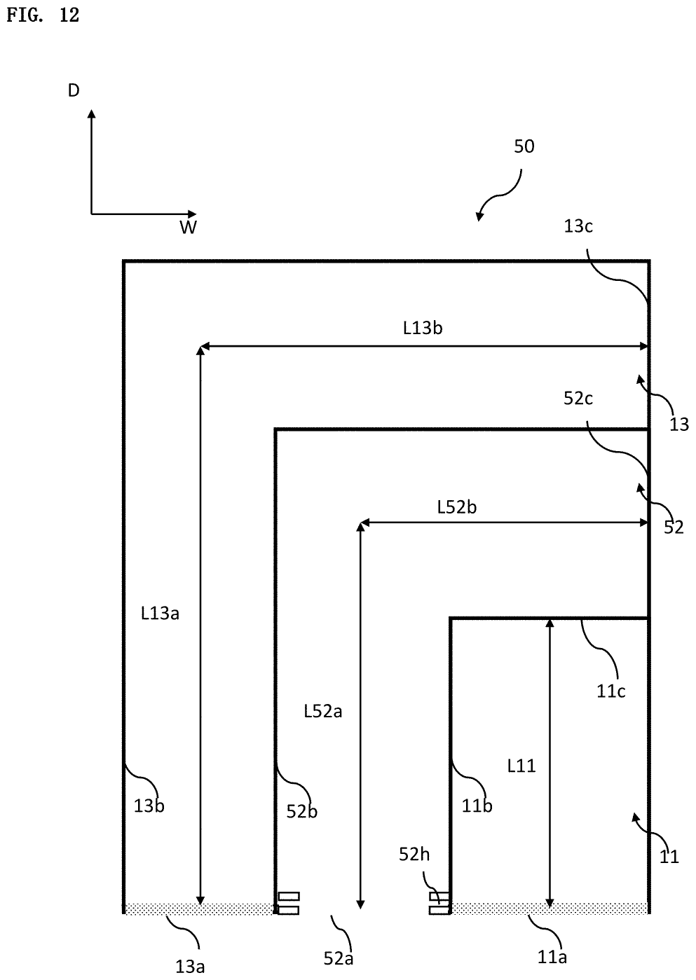

The configuration of the sound absorbing structure is described below. FIG. 11 shows a perspective view of the sound absorbing structure of Modification 3. FIG. 12 shows a DW cross section of the sound absorbing structure of Modification 3.

As shown in FIG. 11, the sound absorbing structure 50 has a first waveguide 11, a second waveguide 52, and a third waveguide 13. The first waveguide 11 and third waveguide 13 are the same as in the first embodiment.

As shown in FIG. 12, the second waveguide 52 has a second open end 52 a, a second sidewall 52b, and a second closed end 52c. The second waveguide 52 is arranged such that a second open end 52a is in contact with the first open end 11a and the second sidewall 52b is in contact with the first sidewall 11b and the first closed end 11c.

The length of the second waveguide 52 is L52a+L52b. The length of the second waveguide 52 is longer than the length of the first waveguide 11. In other words, the second waveguide 52 can absorb sound waves of lower frequency than the first waveguide 11.

The second open end 52a differs from the second open end 12a of the first embodiment in that a perforated plate 52g with a plurality of holes through which sound waves can enter can be attached and detached. The perforated plate 52g corresponds to an acoustic impedance matching component. In other respects, the second open end 52a is identical to the second open end 12a.

The second sidewall 52b differs from the second sidewall 12b of the first embodiment in that it has a groove 52h at the end of the second open end 52a side. The perforated plate 52g can be attached to the groove 52h. In other respects, the second sidewall 52b is identical to the second sidewall 12b.

The second closed end 52c is the same as the second closed end 12c according to the first embodiment.

By inserting the perforated plate 52g into the groove 52h, the perforated plate 52 g can be attached to the second waveguide 52. By pulling the perforated plate 52g out of the groove 52h, the perforated plate 52g can be removed from the second waveguide 52.

According to the sound absorbing structure 50 of Modification 3, it is easy to replace the perforated plate 52g with another perforated plate with different hole parameters. In other words, it is possible to customize the sound absorption coefficient characteristics of the waveguide according to the frequency characteristics of the noise to be absorbed, while standardizing the basic structure of each waveguide, such as its shape and dimensions.

According to the sound absorbing structure 50 of Modification 3, the perforated plate 52g can be easily removed for cleaning, inspection or repair, or replaced with a new perforated plate. In other words, it can improve maintainability.

In the above description, the second waveguide 12 in the sound absorbing structure 10 of the first embodiment was replaced by a second waveguide 52. However, a groove can be provided in the sidewall of any waveguide included in the sound absorbing structure 10 or any waveguide included in the sound absorbing structure 20 of the second embodiment, to allow the perforated plate to be attached to and detached from the waveguide.

### (3-4) Modification 4

Modification 4 is described. Modification 4 is an example of a three-dimensional member with a with a plurality of waveguides is configured so that the perforated plate can be attached to and detached from it in a manner different from that in Modification 3.

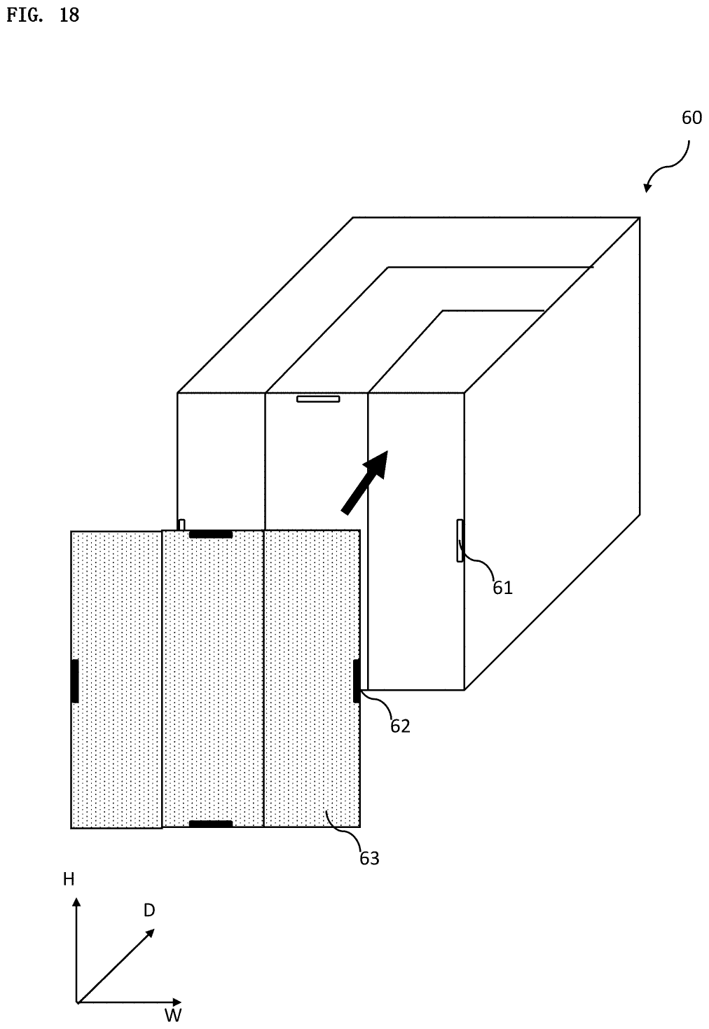

The configuration of the sound absorbing structure 60 is described below. FIG. 18 is a perspective view of the sound absorbing structure 60 of Modification 4. The configuration of the sound absorbing structure 60 is the same as that of the sound absorbing structure 10 described using FIG. 1, except for the perforated plate 63 and the mechanism for its attachment and detachment. The configuration of any of the above mentioned embodiments, such as sound absorbing structure 20 or sound absorbing structure 30, may be used instead of the configuration of sound absorbing structure 10.

The sound absorbing structure 60 has a projection 61 for holding the perforated plate 63. On the other hand, the perforated plate 63 has a hole 62 into which the projection 61 can be inserted. By pushing the perforated plate 63 in the direction D so that the projection 61 and hole 62 fit together, the perforated plate 63 is fixed to the sound absorbing structure 60. The perforated plate 63 fixed to the sound absorbing structure 60 can then be removed by pulling it out in the opposite direction of D.

According to the sound absorbing structure 60 of Modification 4, it is easy to replace the perforated plate 63 with another perforated plate with different hole parameters. In other words, it is possible to customize the sound absorption coefficient characteristics of the waveguide according to the frequency characteristics of the noise to be absorbed, while standardizing the basic structure of each waveguide, such as its shape and dimensions.

According to the sound absorbing structure 60 of Modification 4, the perforated plate 63 can be easily removed for cleaning, inspection or repair, or replaced with a new perforated plate. In other words, it can improve maintainability.

In the example shown in FIG. 18, the perforated plate corresponding to the three waveguides is assumed to be constructed as a single unit. However, not limited to this, a similar mating structure may be used to make each of the multiple perforated plates detachable from the sound absorbing structure 60.

### (3-5) Modification 5

Modification 5 is described. Modification 5 is an example where the sound absorbing structure is divided into multiple blocks.

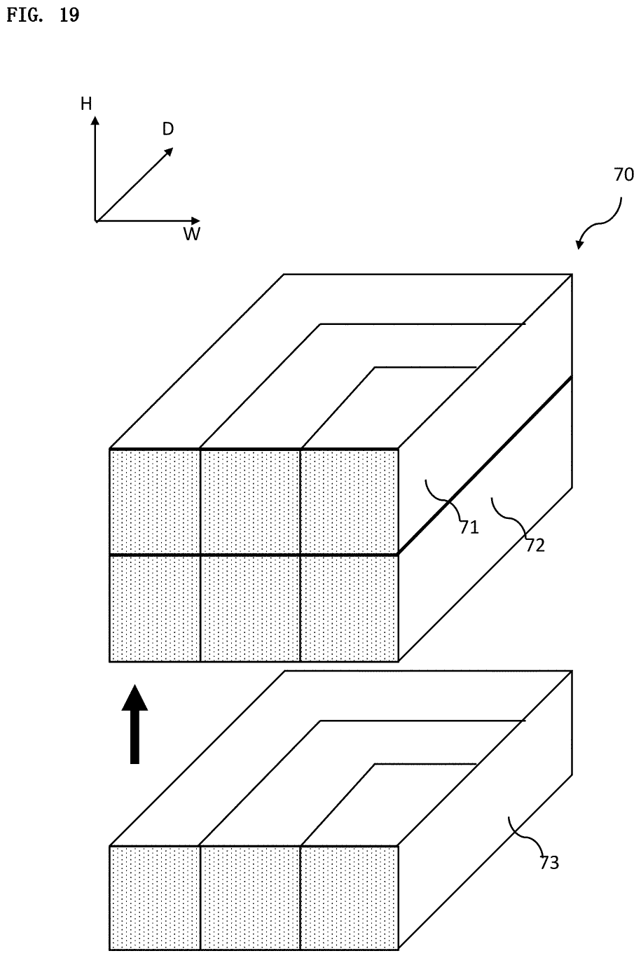

The configuration of the sound absorbing structure 70 is described below. FIG. 19 is a perspective view of the sound absorbing structure 70 of Modification 5. The sound absorbing structure 70 is composed by stacking blocks 71, 72, and 73 in the H direction. The configuration of each block is similar to that of the sound absorbing structure 10 described using FIG. 1, except for the height in the H direction. The configuration of any of the above mentioned embodiments, such as sound absorbing structure 20 or sound absorbing structure 30, may be used instead of the configuration of sound absorbing structure 10. The blocks 71, 72, and 73 may be configured to be fixed to each other via mating portions.

According to the sound absorbing structure 70 of Modification 5, the lengths of each waveguide in the D and W directions are maintained, while the H direction can be shortened. In other words, the length of the block in the H direction can be shortened while maintaining the same sound absorbing structure as in the sound absorbing structure 10. For example, when each block is produced by injection molding, the longer the length of the block in the H-direction, the more likely the sidewall in the block will be deformed during the cooling process for production, making it difficult to obtain the desired sound absorption characteristics. The same problem also arises when other factors cause deformation of the sidewall. According to the sound absorbing structure 70 of Modification 5, by shortening the length of each block in the H direction, the risk of deterioration of sound absorption characteristics due to deformation of the sidewall can be reduced.

### (3-6) Modification 6

Modification 6 is described. Modification 6 is an example where the sound absorbing structure has a rib to suppress deformation while maintaining the length of the waveguide.

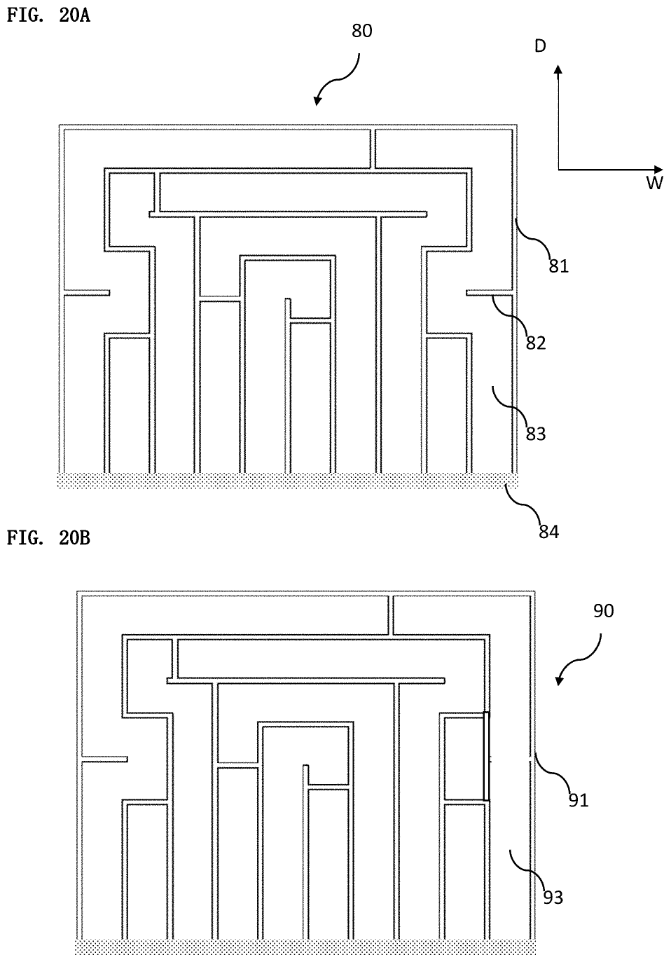

The configuration of the sound absorbing structure 80 is described below. FIG. 20A is a DW cross-sectional view of the sound absorbing structure 80 of Modification 6. As shown in FIG. 20A, the sound absorbing structure 80 has a structure that applies and combines the waveguide structure described using FIGS. 2 and 6. In other words, the sound absorbing structure 80 includes an unbent I-shaped waveguide, a waveguide with one or more bends, and a perforated plate 84. The sound absorbing structure 80 has a sidewall 81 and a rib 82.

Now consider the sound absorbing structure 90 shown in FIG. 20B. The sound absorbing structure 90 has a structure in which the waveguide 83 with a shape bent five times in the sound absorbing structure 80 is replaced by a waveguide 93 with a shape bent once, and the rib 82 is removed. When the sound absorbing structure 90 is produced by injection molding, for example, the long width of the sidewall 91 makes the sidewall 91 more prone to deformation during the cooling process for production, making it difficult to obtain the desired sound absorbing characteristics. The same problem also arises when other factors cause deformation of the sidewall.

On the other hand, if rib 82 in sound absorbing structure 80 is arranged at the same position in sound absorbing structure 90, sidewall 91 is less likely to collapse inward or outward of the sound absorbing structure 80, and deformation can be suppressed. However, in this case, the waveguide 93 is shortened by being separated at the rib, which reduces the sound absorption characteristics of the low-frequency band by the waveguide 93.

Therefore, in the sound absorbing structure 80, while providing the rib 82 on the sidewall 81, the waveguide 83 is bent multiple times in order to increase the length of the waveguide. According to the sound absorbing structure 80 of Modification 6, the reduction of the sound absorption characteristics of the sound absorbing structure 80 due to the deformation of the sidewall 81 can be suppressed while the reduction of the sound absorption characteristics of the low frequency band by the waveguide 83 can be suppressed.

### (4) Other Modifications

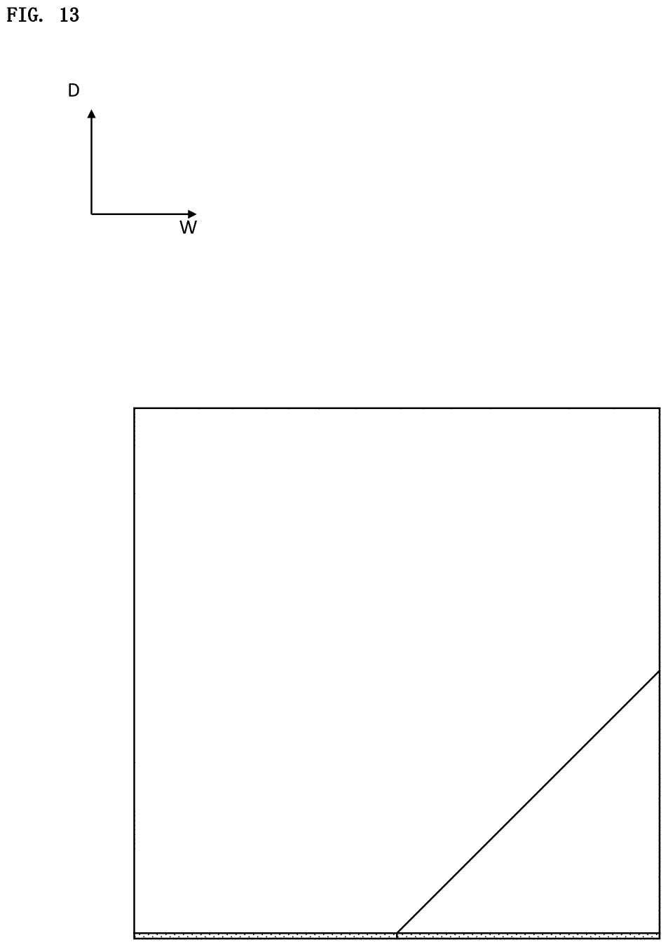

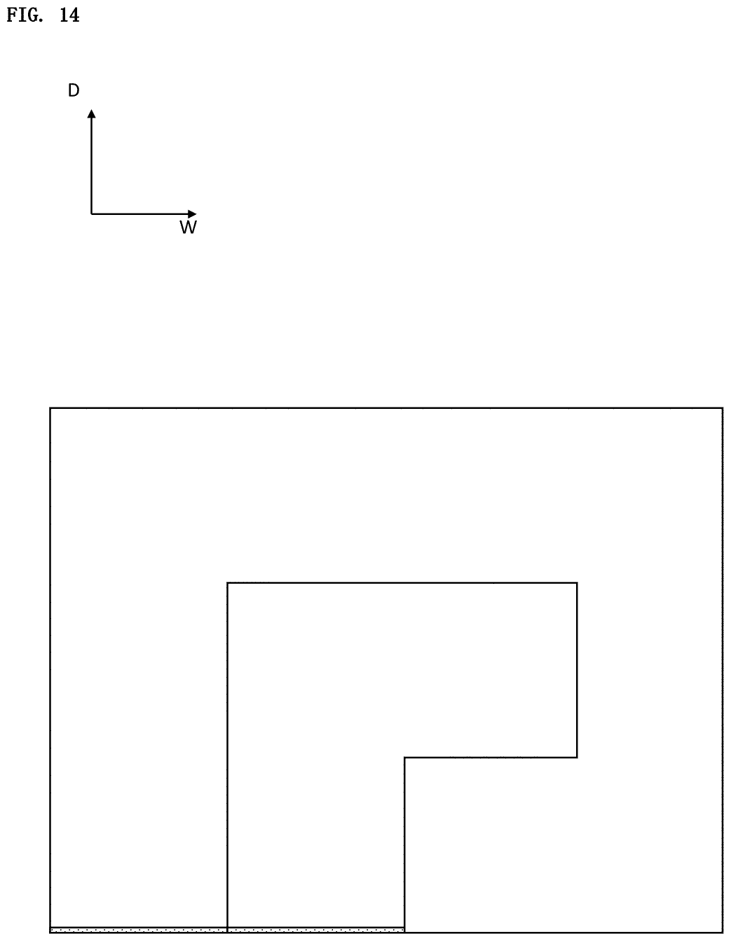

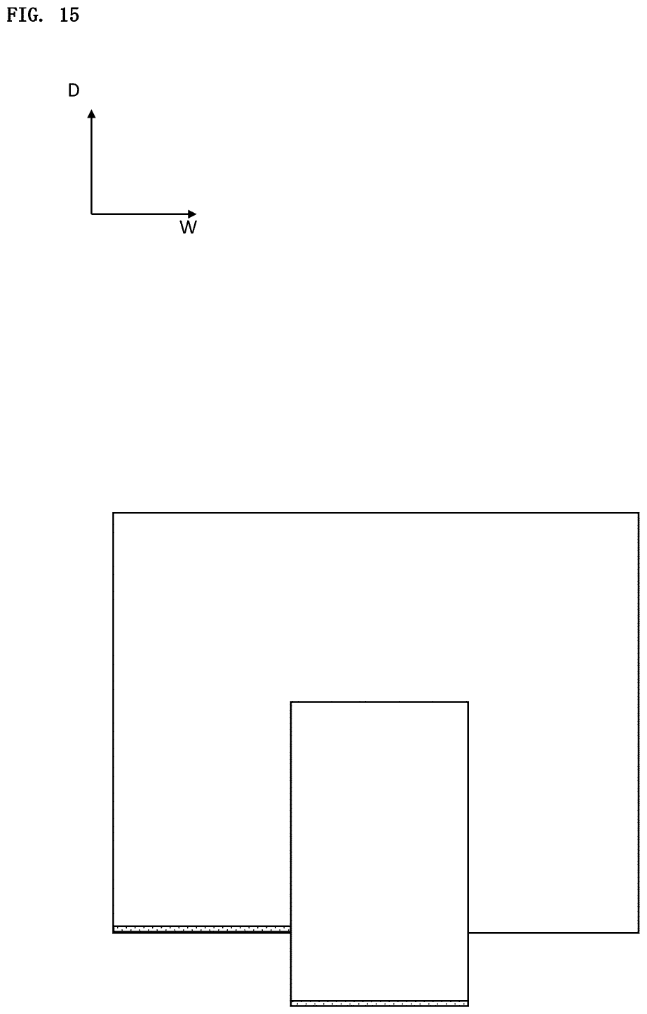

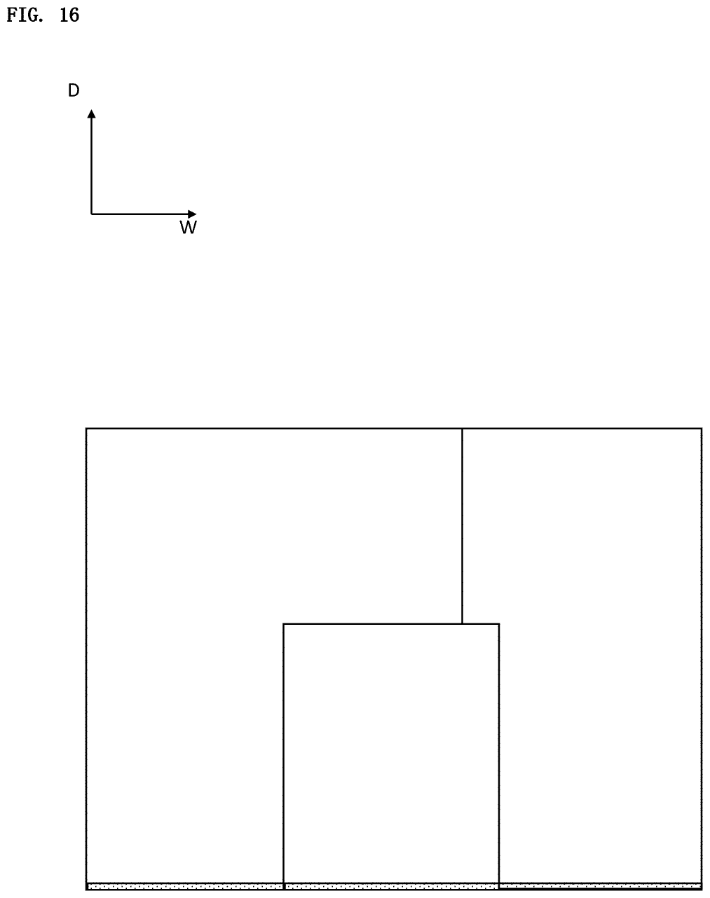

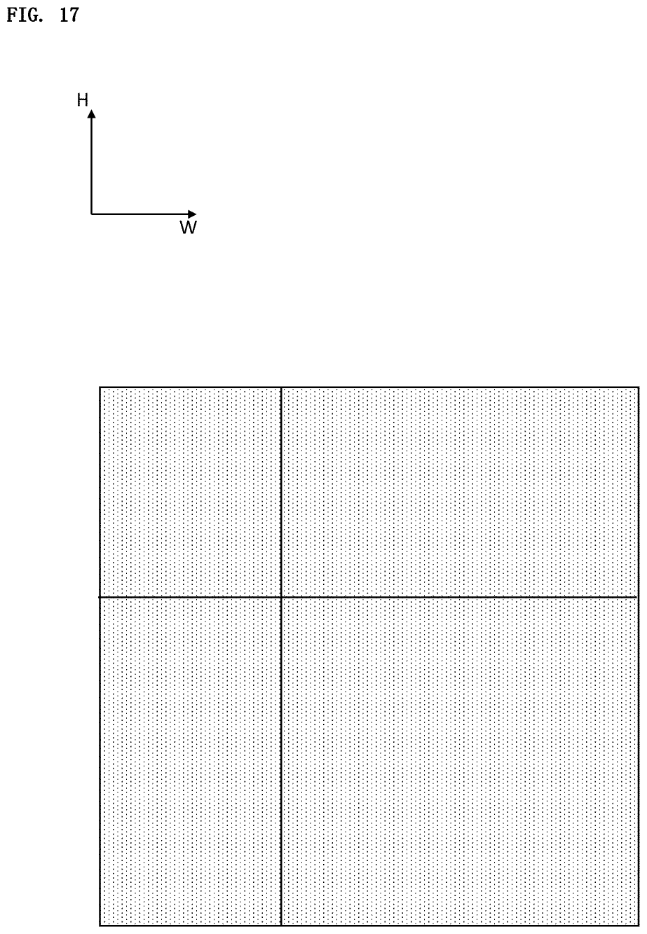

FIG. 13 shows a DW cross section of another modification of the sound absorbing structure. FIG. 14 shows a DW cross section of another modification of the sound absorbing structure. FIG. 15 is a HW cross-sectional view of another modification of the sound absorbing structure. FIG. 16 shows a DW cross section of another modification of the sound absorbing structure. FIG. 17 shows a DW cross section of another modification of the sound absorbing structure.

In FIGS. 13 through 17, dotted areas represent open ends and solid lines represent sidewalls or closed ends.

In the above description, the sound absorbing structure includes three waveguides of different lengths. However, the sound absorbing structure may include four or more waveguides of different lengths or two waveguides of different lengths. In any case, by making the longest waveguide of the sound absorbing structure in a bent shape (in other words, making the DW cross section non-I-shaped), both effective absorption of low frequency sound and thickness suppression can be achieved.

In the above description, an example is given where the sidewall of each waveguide of the sound absorbing structure extends parallel or perpendicular to the normal of the open end (i.e., the D direction). However, the sidewall may extend non-parallel and non-perpendicular to the normal of the open end. For example, as shown in FIG. 13, the sidewall may extend at an angle to the normal of the open end.

In the above description, we have shown two examples: one in which the sidewall of the waveguide of the sound absorbing structure are not bent, and the other in which they are bent once or twice. However, as shown in FIG. 14, the sidewall may be bent three or more times.

In the above explanation, an example is given where the open ends of adjacent waveguides are adjacent to each other. However, as shown in FIG. 15, the open ends of adjacent waveguides need not touch each other.

In the above explanation, an example of stacking the plurality of waveguides so that the open ends of the plurality of waveguides are aligned along the W direction is shown. However, the plurality of waveguides may be stacked so that the open ends of the plurality of waveguides are aligned along the H direction, or as shown in FIG. 17, the plurality of waveguides may be stacked so that the open ends of the plurality of waveguides are aligned in both the H and W directions. As shown in FIG. 17, differentiating the area of the open end of each waveguide from each other has the advantage of suppressing the Q-value for each waveguide.

In the second embodiment, we explained that the surface of the reflective wall may serve as the first closed end 21c and the back surface of the reflective wall may serve as the third closed end 23c, and that such a reflective wall may be considered to functionally divide a waveguide with open ends into a first waveguide 21 and a third waveguide 23 by dividing the interior space of the waveguide into two parts. However, as shown in FIG. 16, by changing the position of such s reflective wall, the first waveguide 21 and the third waveguide 23 can be transformed into two waveguides with L-shaped sidewall of different lengths.

In the above description, the bending angle of the sidewall of the longest waveguide of the sound absorbing structure is 90 degrees. However, such bending angles are arbitrary. In other words, the sidewall of the longest waveguide includes a first portion extending along a first straight line and a second portion extending along a second straight line that intersects the first straight line, and the angle between the first straight line and the second straight line should be different from 180 degrees.

In the above description, the waveguide that the sound absorbing structure has is assumed to bend in the direction on the DW plane. In other words, the shape of the waveguide in the DW cross-section of one sound absorbing structure shall be the same regardless of the position in the H direction of the cross-section. However, the waveguides that the sound absorbing structure have may be bent in three dimensions, and the shape of the waveguide in the DW cross-section of one sound absorbing structure may differ depending on the position in the H direction of the cross-section.

In the above description, the longest waveguide of the sound absorbing structure is bent. However, such waveguide is only required if the sidewall of the waveguide have a contour shape that is different from the curved surface formed by the straight lines connecting the points on the contour line of the open end of the waveguide and the points on the contour line of the closed end of the waveguide. In other words, it is not essential that the waveguide be in a bent shape. For example, a waveguide may include portions extending along a curve.

In the above explanation, an acoustic impedance matching component (perforated plate) is provided at the open end of each waveguide. Additional matching components may be added between the open and closed ends of each waveguide. This matching component may be configured to be removable like the perforated plate in Modification 3.

In the above description, an example of a noise barrier 1 with a plurality of sound absorbing structures 10 stacked along the H and W directions is shown. However, various shapes of noise barriers can be formed by stacking any of the sound absorbing structures described above along any direction.

In the above description, the sound absorbing structure is a rectangular prism, the perforated surface is on one side of the rectangular prism, and the interior of the sound absorbing structure is divided into multiple cavities by sidewall. However, the external shape of the sound absorbing structure is not limited to a rectangular prism, but may be any other polyhedron or sphere. The perforated surface may be provided on only a portion of one face of the sound absorbing structure or on multiple faces of the sound absorbing structure. The sound absorbing structure may also contain structures other than cavities.

### (5) Applications of Sound Absorbing Structures

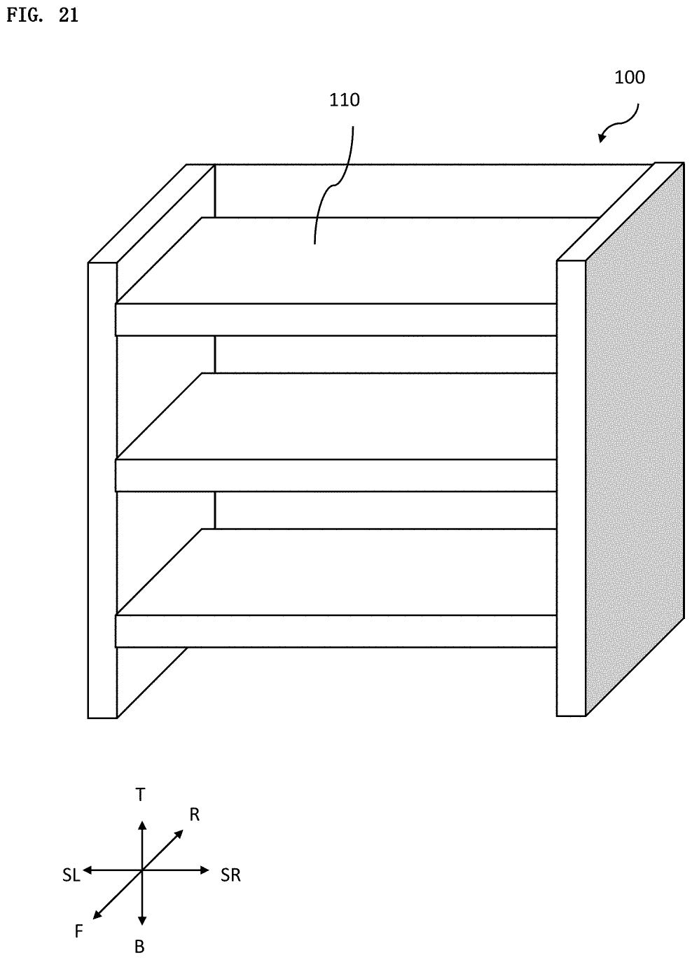

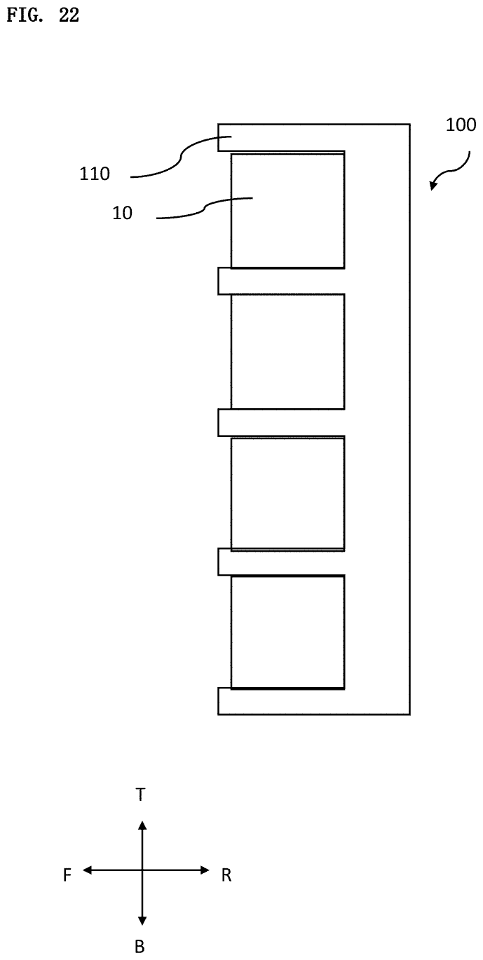

The following is a description of the application of sound absorbing structures. FIG. 21 is a perspective view of the support unit that supports the sound absorbing structure. FIG. 22 illustrates the support of the sound absorbing structure by the support unit.

By combining multiple sound absorbing structures 10, it is possible to construct a sound absorbing wall 100 with the desired external shape. The following description focuses on the case where the sound absorbing wall 100 is a flat wall shape, but the external shape of the sound absorbing wall 100 is not limited to this and may be dome-shaped or box-shaped, for example. The sound absorbing wall 100 can be used, for example, for soundproofing panels, noise barriers, room walls, ceilings, and floors. In the following description, the vertical axis is defined as the T-B axis. The two axes that constitute the Cartesian coordinate system together with the vertical axis (T-B axis) are defined as the F-R and SL-SR axes, respectively. In this Cartesian coordinate system, we define upward (T direction), downward (B direction), forward (F direction), backward (R direction), left (SL direction), and right (SR direction).

The sound absorbing wall 100 is constructed by installing a plurality of sound absorbing structures 10 on a support unit 110 that supports the sound absorbing structures 10. As shown in FIG. 21, the support unit 110 has beams that extend in the left-right (SL-SR) direction. The support unit 110 fixes the sound absorbing structure 10 to the beam, thereby supporting the sound absorbing structure 10 so that it assumes a predetermined posture.

Specifically, the support unit 110 supports the sound absorbing structure 10 so that the D direction (i.e., normal direction of the perforated plate) of the sound absorbing structure 10 is not perpendicular to the direction of sound waves from the noise source (i.e., the rear direction of the sound absorbing wall 100 (R direction)). Preferably, the support unit 110 supports the plurality of sound absorbing structures 10 so that the D-direction of the plurality of sound absorbing structures 10 are all roughly parallel to the direction of travel of the sound waves from the noise source.

For example, as shown in FIG. 22, the support unit 110 may support the sound absorbing structure 10 so that the H-direction of each sound absorbing structure 10 is in the upper direction (T-direction). By installing the sound absorbing structure 10 in such an orientation, sound waves are incident perpendicular to the perforated plates of the sound absorbing structure 10, and the sound absorbing characteristics of the structure are optimized.

As mentioned above, the sound absorbing structure 10 combines sound absorption over a wide bandwidth with thickness suppression. Therefore, according to the sound absorbing wall 100 in which the sound absorbing structure 10 is installed, it is possible to construct a thin-walled (thinner thickness) sound absorbing wall whose external shape can be freely customized and which can absorb sound over a wide bandwidth.

Instead of the sound absorbing structure 10, the sound absorbing structures in each of the embodiments and modifications described above, such as the sound absorbing structure 20 and the sound absorbing structure 30, may be used to configure the sound absorbing wall 100. By using multiple sound-absorbing structures of different structures to construct a sound-absorbing wall 100, it is possible to provide the sound-absorbing wall 100 with various sound-absorbing characteristics.

### (5-1) Modification of Sound Absorbing Wall

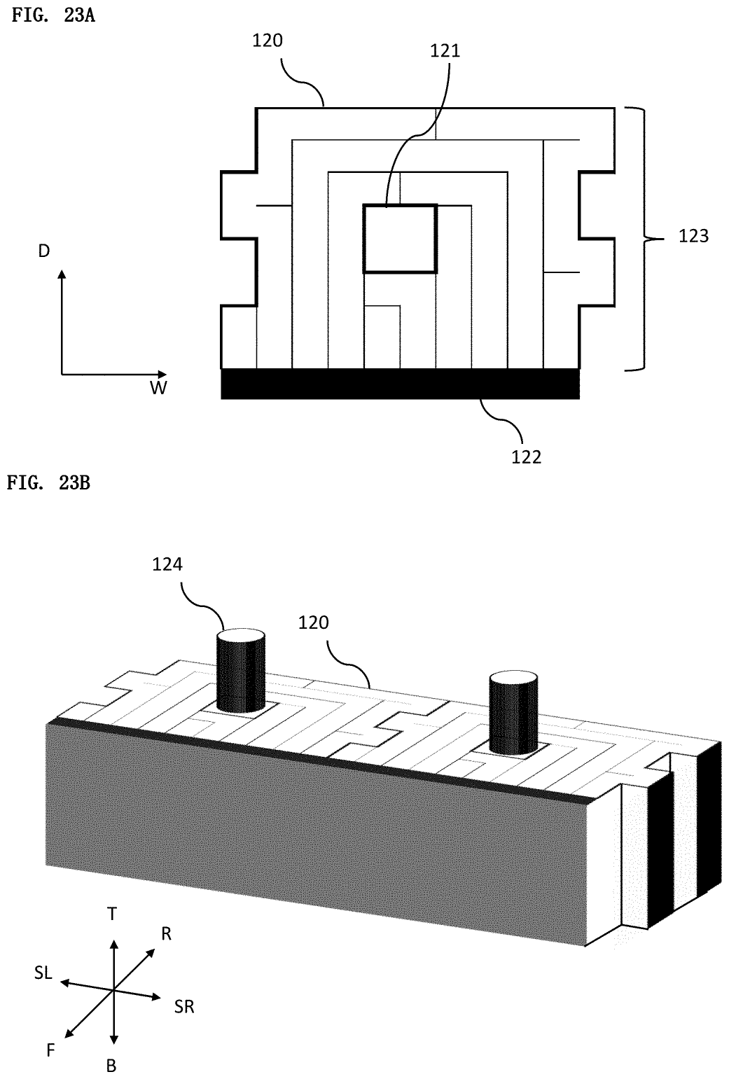

A modification of a sound absorbing wall is described below. FIG. 23A is a DW cross-sectional view of the configuration of the sound absorbing structure in a modification of the sound absorbing wall. FIG. 23B illustrates how multiple sound absorbing structures are assembled in a modification of a sound absorbing wall.

As shown in FIG. 23A, the sound absorbing structure 120 has a perforated plate 122 and a plurality of waveguides, similar to the sound absorbing structure 80 described using FIG. 20A. However, in the sound absorbing structure 120, a space 121 where no waveguide is present when viewed from the H direction (i.e., in the DW cross-section) is provided. The sound absorbing structure 120 has a mating portion 123 with an uneven outer wall. By having such a structure of sound absorbing structure 120, multiple sound-absorbing structures 120 can be easily combined to form a sound absorbing wall.

Specifically, as shown in FIG. 23B, when a plurality of sound absorbing structures 120 are lined up in the horizontal direction (SL-SR direction), the mating portions 123 of the plurality of sound absorbing structures 120 can be easily fixed by mating them with each other. In addition, since the mating portion 123 constitutes a part of the waveguide, compared to the case where a structure for fixing is added to the sound absorbing structure 120 separately from the waveguide, the space in the sound absorbing structure 120 can be effectively utilized for sound absorption and the sound absorption performance of the sound absorbing wall can be improved.

As shown in FIG. 23B, a prop 124 can be inserted into the space 121 that the sound absorbing structure 120 has. Then, a plurality of sound absorbing structures 120 can be easily fixed by stacking the plurality of sound-absorbing structures 120 in the height direction (T-B direction) so that the prop 124 passes through the space 121 of each sound-absorbing structure 120. According to this configuration, unlike the case of a sound absorbing wall using the support unit 110 described in FIGS. 21 and 22, beams are not required, so the gap between the plurality of sound-absorbing structures 120 aligned in the height direction is smaller, thereby enhancing the sound absorbing performance of the sound-absorbing wall. In addition, unlike when a sound absorbing wall is constructed using the support unit 110, a member to support the back of the sound absorbing structure 120 is not necessary, so the thickness (dimension in the F-R direction) of the sound absorbing wall can be reduced. Furthermore, the use of a lightweight material, such as rigid polyvinyl chloride for example, as the material of the prop 124 can reduce the weight of the sound absorbing wall and improve the convenience of the sound-absorbing wall. However, the material of the prop 124 is not limited to this and may be made of aluminum or iron, for example.

According to the present disclosure, high sound absorption coefficient can be achieved over a wide bandwidth while suppressing the thickness of the sound absorbing structure.

Although the embodiments of the present invention are described in detail above, the scope of the present invention is not limited to the above embodiments. Further, various modifications and changes can be made to the above embodiments without departing from the spirit of the present invention. In addition, the above embodiments and modifications can be combined.

### (5) Appendix

The matters described in the embodiment are appended below.

### APPENDIX 1

A sound absorbing structure (10, 20, 30, 40, 50), comprising:

a first waveguide (11b, 21b) that has a first open end (11a, 21a), a first closed end (11c, 21c), and a first sidewall connecting the first open end and the first closed end; and

a second waveguide (12, 22, 32, 42, 52) that has a second open end (12a, 22a, 32a, 42a, 52a), a second closed end (12c, 22c, 32c, 42c, 52c), and a second sidewall (12b, 22b, 32b, 42b, 52b) connecting the second open end and the second closed end, and wherein

the first open end is provided with a first perforation plate having a plurality of first holes through which sound waves are able to be incident,

the second open end is provided with a second perforation plate having a plurality of second holes through which sound waves are able to be incident,

a length of the second waveguide is longer than a length of the first waveguide,

the second waveguide is arranged such that at least a portion of the second sidewall is in contact with the first sidewall, and

the second sidewall has a portion extending non-parallel to a normal of the second open end.

According to (Appendix 1), it is possible to achieve both effective absorption of low-frequency sound and thickness suppression, as well as high sound absorption coefficient over a wide bandwidth.

### APPENDIX 2

The sound absorbing structure according to Appendix 1, wherein

the second sidewall includes a first portion extending along a first straight line and a second portion extending along a second straight line that intersects the first straight line, and

a first angle between the first straight line and the second straight line is different from 180 degrees.

According to (Appendix 2), it is possible to achieve both effective absorption of low-frequency sound and thickness suppression, as well as high sound absorption coefficient over a wide bandwidth.

### APPENDIX 3

The sound absorbing structure according to Appendix 2, wherein

the first angle is 90 degrees,

the first straight line is normal to the second open end, and

the second straight line is normal to the second closed end.

According to (Appendix 3), it is possible to achieve both effective absorption of low-frequency sound and thickness suppression, as well as high sound absorption coefficient over a wide bandwidth.

### APPENDIX 4

The sound absorbing structure according to Appendix 1, wherein

the second sidewall includes a first portion extending along a first straight line, a second portion extending along a second straight line intersecting the first straight line, and a third portion extending along a third straight line intersecting the second straight line,

a first angle between the first straight line and the second straight line is different from 180 degrees, and

a second angle between the second straight line and the third straight line is different from 180 degrees.

According to (Appendix 4), it is possible to achieve both effective absorption of low-frequency sound and thickness suppression, as well as high sound absorption coefficient over a wide bandwidth.

### APPENDIX 5

The sound absorbing structure according to Appendix 4, wherein

the first and second angles are 90 degrees,

the first straight line is normal to the second open end and

the third straight line is normal to the second closed end.

According to (Appendix 5), it is possible to achieve both effective absorption of low-frequency sound and thickness suppression, as well as high sound absorption coefficient over a wide bandwidth.

### APPENDIX 6

The sound absorbing structure according to Appendix 1, wherein the second sidewall includes a portion extending along a curve.

According to (Appendix 6), it is possible to achieve both effective absorption of low-frequency sound and thickness suppression, as well as high sound absorption coefficient over a wide bandwidth.

### APPENDIX 7

The sound absorbing structure according to any of Appendices 1 to 6, further comprising a third waveguide (13, 23) that has a third open end (13a, 23a), a third closed end (13c, 23c), and a third sidewall (13b, 23b) connecting the third open end and the third closed end, and wherein

the third open end is provided with a third perforated plate having a plurality of third holes through which sound waves are able to be incident,

a length of the third waveguide is longer than the length of the second waveguide,

the third waveguide is arranged such that at least a portion of the third sidewall is in contact with the second sidewall, and

the third sidewall has a portion extending non-parallel to a normal of the third open end.

According to (Appendix 7), it is possible to achieve both effective absorption of low-frequency sound and thickness suppression, as well as high sound absorption coefficient over a wide bandwidth.

### APPENDIX 8

The sound absorbing structure according to any of Appendices 1 to 7, wherein hole parameters of the first perforated plate are different from hole parameters of the second perforated plate.

According to (Appendix 8), the hole parameters of the perforated plate at the open end of each waveguide are optimized according to the sound absorption coefficient characteristics required for that waveguide, so that high sound absorption coefficient can be achieved over a wide bandwidth.

### APPENDIX 9

The sound absorbing structure according to Appendix 8, wherein

The hole parameters include at least one of the following: an area of the sound wave incident surface, a thickness of the perforated plate, a diameter of the hole, a occupancy of the hole, and a shape of the hole.

According to (Appendix 9), the hole parameters of the perforated plate at the open end of the waveguide are optimized according to the required sound absorption coefficient characteristics of the waveguide in question, so that high sound absorption coefficient can be achieved over a wide bandwidth.

### APPENDIX 10

The sound absorbing structure according to any of Appendices 1 to 9, further comprising a reflector (32d) installed in the second waveguide and capable of reflecting sound waves, and wherein

the reflector is configured to slide in the second waveguide between the second open end and the second closed end,

the length of the second waveguide is limited to a length from the second open end to the location of the reflector.

According to (Appendix 10), it is possible to customize the resonance frequency according to the frequency characteristics of the noise to be absorbed, while standardizing the basic structure such as the shape and dimensions of the second waveguide.

### APPENDIX 11

The sound absorbing structure according to any of Appendices 1 to 10, wherein

the second sidewall has a groove (421) between the second opening end and the second closing end, and a reflector (41e) is able to be mounted in the groove, and

when the reflector is installed, the length of the second waveguide is limited to the length from the second open end to a location of the reflector.

According to (Appendix 11), it is possible to customize the resonance frequency according to the frequency characteristics of the noise to be absorbed, while standardizing the basic structure such as the shape and dimensions of the second waveguide.

### APPENDIX 12

The sound absorbing structure according to any of Appendices 1 to 11, wherein

the first perforated plate is configured to be removable from the first open end, and

the second perforated plate (52g) is configured to be removable with respect to the second open end.

According to (Appendix 12), it is possible to customize the sound absorption coefficient characteristics of each waveguide according to the frequency characteristics of the noise to be absorbed while standardizing the basic structure such as the shape and dimensions of each waveguide, and it is also possible to improve the ease of maintenance.

### APPENDIX 13

The sound absorbing structure according to any of appendices 1 to 12, wherein the second waveguide is arranged such that the second open end is in contact with the first open end.

According to (Appendix 13), it is possible to achieve both effective absorption of low-frequency sound and thickness suppression, as well as high sound absorption coefficient over a wide bandwidth.

### APPENDIX 14

A sound absorbing structure comprising:

a first waveguide (21 and 23) that has a first open end (21a), a second open end (23a)

positioned in contact with the first open end, and a sidewall (21b and 23b) connecting the first and second open ends; and

a reflective walls (21c and 23c) located in the sidewall and capable of reflecting sound waves, and wherein

the first open end is provided with a first perforation plate having a plurality of first holes through which sound waves can be incident,

the second open end is provided with a second perforation plate having a plurality of second holes through which sound waves can be incident,

an interior space of the sidewall is divided into a first space from the first open end to the reflective wall and a second space from the second open end to the reflective wall, and

a length from the second open end to the reflective wall is longer than a length from the first open end to the reflective wall.

According to (Appendix 14), it is possible to achieve both effective absorption of low-frequency sound and thickness suppression, as well as high sound absorption coefficient over a wide bandwidth.

### REFERENCE SIGNS LIST

1: Noise barrier
10: Sound absorbing structure
11: First waveguide
12: Second waveguide
13: Third waveguide
20: Sound absorbing structure
21: First waveguide
22: Second waveguide
23: Third waveguide
30: Sound absorbing structure
32: Second waveguide
40: Sound absorbing structure
42: Second waveguide
50: Sound absorbing structure
52: Second waveguide

1. A sound absorbing structure comprising:
a perforated surface with a plurality of through-holes;
a first cavity that has a portion extending non-parallel to a normal direction of the perforated surface, the first cavity being breathable between an interior and exterior of the first cavity via through-holes existing in a first region of the perforated surface; and
a second cavity that is breathable between an interior and exterior of the second cavity via through-holes existing in a second region adjacent to the first region of the perforated surface.

2. The sound absorbing structure according to claim 1, wherein the first cavity has a first portion extending from the perforated surface substantially parallel to the normal direction of the perforated surface and a second portion extending from the first portion non-parallel to the normal direction of the perforated surface.

3. The sound absorbing structure according to claim 2, wherein the second portion extends from the first portion perpendicular to the normal direction of the perforated surface.

4. The sound absorbing structure according to claim 2, wherein the first cavity has a third portion extending from the second portion substantially parallel to the normal direction of the perforated surface.

5. The sound absorbing structure according to claim 1, wherein the second cavity has a portion extending non-parallel to the normal direction of the perforated surface.

6. The sound absorbing structure according to claim 1, wherein the second cavity has a fourth portion extending from the perforated surface substantially parallel to the normal direction of the perforated surface and a fifth portion extending from the fourth portion substantially perpendicular to the normal direction of the perforated surface.

7. The sound absorbing structure according to claim 1, wherein the first cavity and the second cavity overlap at least partially as viewed from the normal direction of the perforated surface.

8. The sound absorbing structure according to claim 1, wherein the first cavity and the second cavity function as resonators with different resonance characteristics from each other.

9. The sound absorbing structure according to claim 1, comprising a third cavity that extends from the perforated surface substantially parallel to the normal direction of the perforated surface, being breathable an interior and exterior of the third cavity via through-holes existing in a third region adjacent to the second region of the perforated surface.

10. The sound absorbing structure according to claim 1, wherein at least one of a number and diameter of the through-holes in the first region of the perforated surface is different from that of the through-holes in the second region of the perforated surface.

11. The sound absorbing structure according to claim 1, wherein a hole diameter of each of the plurality of through-holes existing in the perforated surface is between 0.3 mm and 2 mm.

12. The sound absorbing structure according to claim 1, wherein an average sound absorption coefficient of sound between 400 Hz and 1500 Hz by the sound absorbing structure is higher than an average sound absorption coefficient of sound in other frequency bands by the sound absorbing structure.

13. The sound absorbing structure according to claim 1, wherein the sound absorbing structure is rectangular prism,
the perforated surface is on one side of the rectangular prism, and
an interior of the sound absorbing structure is divided into a plurality of cavities by sidewalls.

14. The sound absorbing structure according to claim 1, wherein the sound absorbing structure is formed by injection molding.

15. The sound absorbing structure according to claim 1, comprising means for adjusting a length of the first cavity in the extending direction.

16. The sound absorbing structure according to claim 1, wherein the perforated surface is a face of a plate-like member that is able to be attached to or detached from a three-dimensional member with the first cavity and the second cavity.

17. The sound absorbing structure according to claim 1, wherein both a length of the first cavity in a first direction in which the first portion of the first cavity extends and a length of the first cavity in a second direction in which the second portion of the first cavity extends are longer than a length of the first cavity in a third direction perpendicular to the first and second directions of the first cavity.

18. The sound absorbing structure according to claim 1, wherein a rib is provided on a sidewall of the sound absorbing structure.

19. A sound absorbing wall comprising a plurality of sound absorbing structures according to claim 1, wherein
the plurality of perforated surfaces of the plurality of sound absorbing structures are arranged adjacent to each other.

20. A sound absorbing wall comprising a plurality of sound absorbing structures according to claim 1, the sound absorbing wall further comprising
a support member that supports the plurality of sound absorbing structures so that the normal directions of the plurality of perforated surfaces of the plurality of sound absorbing structures are substantially parallel to each other.
